(19) United States
(12) Patent Application Publication
(10) Pub. No.: US 2026/0087265 A1
(43) Pub. Date: Mar. 26, 2026

(54) CONTINUALLY EVALUATING AND MODIFYING ARTIFICIAL INTELLIGENCE ASSISTANT

(71) Applicant: Adobe Inc., San Jose, CA (US)

(72) Inventors: Uttaran Bhattacharya, San Jose, CA (US); Yunyao Li, San Jose, CA (US); Xin Fang, San Jose, CA (US); Xiang Chen, Palo Alto, CA (US); Victor Soares Bursztyn, Mountain View, CA (US); Tong Yu, San Jose, CA (US); Saayan Mitra, San Jose, CA (US); Kun Qian, Seattle, WA (US); Eunyee Koh, Sunnyvale, CA (US); Akash Maharaj, San Jose, CA (US)

(21) Appl. No.: 18/893,422

(22) Filed: Sep. 23, 2024

(51) Int. Cl. G06F 40/40

(52) U.S. Cl. CPC G06F 40/40

(57) ABSTRACT

The present disclosure relates to systems, non-transitory computer-readable media, and methods for generating modifications to an LLM based artificial intelligence assistant based on classifying the severity of errors and focusing the modifications on resolving high-severity errors. In particular, the disclosed systems receive prompts via an artificial intelligence assistant graphical user interface and generate responses to the prompts using the LLM based artificial intelligence assistant. Further, the disclosed systems determine errors in the responses using an annotation tool to generate annotated errors and an error analysis mechanism to generate indications of the errors based on the annotated errors. Additionally, the disclosed systems classify the errors as one of high-severity, mid-severity, or low-severity. Moreover, the disclosed systems generate modifications to components of the LLM based artificial intelligence assistant based on the high-severity errors.

### BACKGROUND

Recent years have seen significant improvements in generative artificial intelligence (AI) technology. For example, many organizations use generative conversational AI assistants to perform a variety of tasks, such as answering questions, providing recommendations, scheduling appointments, and even controlling smart devices within various applications such as customer service, personal assistants, and specialized domains (e.g., healthcare, finance, etc.). Conventional conversational AI systems, however, often struggle to generate accurate and contextually appropriate responses. These challenges often arise because conventional conversational AI systems have difficulties continually tracking performance, particularly in cases where such systems are regularly and iteratively implementing changes.

As mentioned, although conventional systems are able to generate conversational responses to prompts, such systems have a number of problems in relation to accuracy. For instance, conventional systems inaccurately generate responses to user prompts due to various challenges with evaluating interplay between components of the conversational AI systems. Specifically, conventional conversational AI systems often include multiple interplaying components that are developed through iterative processes. In such systems, achieving holistic improvement requires a comprehensive evaluation mechanism in conjunction with a benchmark. For example, conversational AI systems typically track the performance changes of the system components as well as the overall performance of the system to determine the accuracy, and therefore usefulness, of the generated responses. Conventional systems incorporate various feedback and benchmarks dealing with the individual components each of which include challenges and/or create additional problems with the accuracy of responses. For example, conventional systems collect explicit feedback via buttons, direct prompts, etc., however, such feedback is typically sparce, not representative of all users, and is often too coarse to capture detailed nuances of user experiences and preferences. Additionally, conventional systems often collect implicit feedback from user interactions within the system such as clicks, views, navigation patterns, etc. Implicit feedback, however, is often unrelated to end goals or preferences of system users. Moreover, conventional systems often incorporate benchmark datasets to evaluate generated responses. Such datasets, however, are often not applicable for domain-specific conversational AI systems. Further, creating domain-specific benchmark datasets is labor intensive, time consuming, and requires domain expertise. Given that the workload and tasks of such systems often evolve over time, continually creating domain-specific benchmark datasets becomes burdensome if not prohibitive.

These along with additional problems and issues exist with regard to conventional conversation AI systems.

### SUMMARY

Embodiments of the present disclosure provide benefits and/or solve one or more of the foregoing or other problems in the art with systems, non-transitory computer-readable media, and methods for continuously improving the performance of a large language model “LLM” based artificial intelligence assistant based on an error classification structure. In particular, in some embodiments, the disclosed systems generate annotations to identify and provide low level details regarding errors in responses generated by the LLM based artificial intelligence assistant. Further, in some implementations, based on these annotated responses, the disclosed systems generate higher level detailed information for the errors. Moreover, in one or more embodiments, the disclosed systems utilize these error indications with higher levels of detail to classify the errors in the responses within severity categories. Furthermore, in one or more implementations, the disclosed systems generate modifications to the LLM based artificial intelligence assistant based on the highest severity category within the error classification structure. Additionally, in some embodiments, the disclosed systems implement this performance improvement model continuously.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which an AI assistant evaluation and improvement system operates in accordance with one or more embodiments.

FIG. 2 illustrates the AI assistant evaluation and improvement system utilizing an annotation tool and an error analysis mechanism to generate classified errors for modifying the LLM based artificial intelligence assistant in accordance with one or more embodiments.

FIG. 3 illustrates the AI assistant evaluation and improvement system using an LLM based artificial intelligence assistant and the annotation tool to generate annotated responses in accordance with one or more embodiments.

FIG. 4 illustrates the AI assistant evaluation and improvement system generating indications of errors in responses and classifying the severity of the errors in accordance with one or more embodiments.

FIG. 5 illustrates the AI assistant evaluation and improvement system utilizing one or more engines to modify the LLM based artificial intelligence assistant in accordance with one or more embodiments.

FIG. 6A illustrates an exemplary annotation graphical user interface in accordance with one or more embodiments.

FIG. 6B illustrates an exemplary annotation graphical user interface in accordance with one or more embodiments.

FIG. 7 illustrates an exemplary error graphical user interface in accordance with one or more embodiments.

FIG. 8 illustrates out-of-scope errors generated by the LLM based artificial intelligence assistant in a first sprint compared with out-of-scope errors generated by a modified LLM based artificial intelligence assistant in a second sprint in accordance with one or more embodiments.

FIG. 9 illustrates an example schematic diagram of the AI assistant evaluation and improvement system in accordance with one or more embodiments.

FIG. 10 illustrates an example series of acts for generating modifications to an LLM based artificial intelligence assistant by classifying errors in responses generated by the LLM based artificial intelligence assistant according to severity in accordance with one or more embodiments.

FIG. 11 illustrates an example series of acts for generating modifications to an LLM based artificial intelligence assistant by classifying errors in responses generated by the LLM based artificial intelligence assistant according to severity in accordance with one or more embodiments.

FIG. 12 illustrates an example series of acts for generating modifications to an LLM based artificial intelligence assistant by classifying errors in responses generated by the LLM based artificial intelligence assistant according to severity in accordance with one or more embodiments.

FIG. 13 illustrates a block diagram of an example computing device for implementing one or more embodiments of the present disclosure.

### DETAILED DESCRIPTION

This disclosure describes one or more embodiments of an AI assistant evaluation and improvement system that continuously improves the performance of an LLM based artificial intelligence assistant based on an error classification structure. In particular, in some implementations, the AI assistant evaluation and improvement system generates annotations to identify and provide low level details regarding errors in responses generated by the LLM based artificial intelligence assistant. Further, in one or more embodiments, based on these annotated responses, the AI assistant evaluation and improvement system generates higher level detailed information for the errors. Moreover, in one or more implementations, the AI assistant evaluation and improvement system utilizes these error indications with higher levels of detail to classify the errors in the responses within severity categories. Furthermore, in some embodiments, the AI assistant evaluation and improvement system generates modifications to the LLM based artificial intelligence assistant based on the highest severity category within the error classification structure. Additionally, in some implementations, the AI assistant evaluation and improvement system implements this performance improvement model continuously.

As mentioned above, in one or more embodiments, the AI assistant evaluation and improvement system generates annotations to identify and provide low level details regarding errors in responses generated by the LLM based artificial intelligence assistant. Specifically, the AI assistant evaluation and improvement system uses an annotation tool to generate these annotated responses. Further, in one or more implementations, the AI assistant evaluation and improvement system provides the responses for annotation to the annotation devices to generate multiple annotated responses for a single response and/or it's corresponding prompt. For example, in these or other embodiments, the system provides a single response/prompt pair to a plurality of annotation devices to generate the multiplicative annotated responses for that response/prompt pair to improve the reliability and robustness of this lower-level detail information.

As noted above, in some embodiments, based on the annotated responses just described, the AI assistant evaluation and improvement system generates higher level detailed information for the errors. In particular, the AI assistant evaluation and improvement system utilizes a plurality of reviewer devices of an error analysis mechanism to generate this information with higher levels of detail. In some implementations, the AI assistant evaluation and improvement system utilizes fewer reviewer devices by comparison with the number of annotation devices of the annotation tool. In these or other embodiments, the AI assistant evaluation and improvement system generates these error indications with higher levels of detail to include information such as patterns of errors, probable causes for the errors/error patterns, and/or potential improvements to the LLM based artificial intelligence assistant.

As mentioned previously, in one or more embodiments, the AI assistant evaluation and improvement system utilizes the error indications with higher levels of detail to classify the errors in the responses within severity categories. In particular, in one or more implementations, the AI assistant evaluation and improvement system categorizes each error as high-severity (or severity 0), mid-severity (or severity 1), or low-severity (or severity 2). To illustrate, in some embodiments, the AI assistant evaluation and improvement system categorizes an error as high-severity by determining that a response appears correct but is incorrect. For example, in some implementations, the error may include a hallucination. Moreover, in one or more embodiments, the AI assistant evaluation and improvement system classifies an error as high-severity by determining the hallucination includes persuasive content such as logical consistencies with accurate information of a subject or other information that cannot easily be verified independently.

As noted previously, in one or more implementations, the AI assistant evaluation and improvement system generates modifications to the LLM based artificial intelligence assistant based on the highest severity categories within the error classification structure. Specifically, in some embodiments, the AI assistant evaluation and improvement system focuses on errors classified as high-severity. For example, based on the errors classified as high-severity, the AI assistant evaluation and improvement system determines modifications to the LLM based artificial intelligence assistant for reducing the number of high-severity errors. For example, the AI assistant evaluation and improvement system determines modifications to one or more specific components of the LLM based artificial intelligence assistant and modifies the LLM based artificial intelligence assistant accordingly.

As previously mentioned, in some implementations, the AI assistant evaluation and improvement system implements this performance improvement model continuously. In particular, the AI assistant evaluation and improvement system not only identifies, analyzes, and classifies errors for the overall LLM based artificial intelligence assistant, but also does so for the components. In other words, in one or more embodiments, the AI assistant evaluation and improvement system collects both end-to-end metrics for the LLM based artificial intelligence assistant as well as component-wise metrics for improvement of individual components of the LLM based artificial intelligence assistant. Moreover, in one or more implementations, the AI assistant evaluation and improvement system 106 implements the LLM based artificial intelligence assistant within a particular enterprise or organization. In these or other embodiments, the needs of the enterprise as well as the source information used thereby, which the LLM based artificial intelligence assistant queries when generating responses, change over time. Accordingly, in these or other embodiments, the AI assistant evaluation and improvement system implements the foregoing acts continuously to ensure continuous improvement and adaptation to changing needs and source information.

As suggested by the foregoing, the AI assistant evaluation and improvement system provides a variety of technical advantages relative to conventional systems. For example, by collecting both end-to-end and component-wise metrics for responses generated by the LLM based artificial intelligence assistant, the AI assistant evaluation and improvement system continuously improves the accuracy of the LLM based artificial intelligence assistant. Indeed, this comprehensive continual improvement framework for evaluation and continual improvement of conversational AI assistants dissects the identification and evaluation of responses from the LLM based artificial intelligence assistant in contrast to the methods of conventional systems as discussed above. Specifically, to improve performance, conventional systems often rely on explicit feedback, which is too coarse and often unrepresentative, implicit feedback, which is often unrelated to end goals and/or user preferences, and benchmark datasets, which are often not applicable for domain-specific conversational AI systems. In contrast, in some embodiments, the AI assistant evaluation and improvement system improves the response accuracy of the LLM based artificial intelligence assistant by dissecting the evaluation of responses into identifying errors and providing low level details of the errors via an annotation tool and analyzing the errors for higher-level detail error information via an error response generator. By using these generators, the AI assistant evaluation and improvement system more accurately determines and analyzes response errors. Furthermore, in some implementations, the AI assistant evaluation and improvement system also improves response accuracy by classifying the errors into different categories of severity before determining and implementing modifications to the LLM based artificial intelligence assistant. By focusing on the highest levels of error categories, the AI assistant evaluation and improvement system generates improvements tailored to the most significant problems for users and resolves and/or reduces these errors, thereby improving the overall accuracy of the LLM based artificial intelligence assistant by comparison with conventional systems. Moreover, in one or more embodiments, the AI assistant evaluation and improvement system continuously implements these acts thereby continuously improving the accuracy even as changes occur within (i) the source data underlying responses and (ii) the needs of an organization using the LLM based artificial intelligence assistant.

As illustrated by the foregoing discussion, the present disclosure utilizes a variety of terms to describe features and advantages of the AI assistant evaluation and improvement system. Additional detail is now provided regarding the meaning of such terms. For example, as used herein, the term “LLM based artificial intelligence assistant” refers to a digital system that utilizes a machine learning model trained text and/or image data to perform a wide range of tasks for users within an organization. Specifically, in one or more implementations, a large language model based artificial intelligence assistant integrates natural language processing capabilities with various functional components to understand, generate, and process human language in response to prompts within an organizational context. For example, a large language model based artificial intelligence assistant automates document review, generates reports, responds to queries based on organizational data such as that contained in digital files of the organization, assists in drafting communications, etc.

Relatedly, as used herein, the term “component” refers to any distinct part of the LLM based artificial intelligence assistant, which contributes to the overall functionality of that system. Specifically, a component of the LLM based artificial intelligence assistant includes individual subsystems, software modules, or tools that perform specialized functions within the broader framework of the LLM based artificial intelligence assistant. For instance, in some embodiments, components of the LLM based artificial intelligence assistant include an LLM, a prompt rewrite component, an intent detection component, a data quality assurance pipeline, a concepts quality assurance pipeline, an out-of-scope pipeline, a response generation component, a chat history/user session database, a documentation collection, an AI assistant graphical user interface, etc.

Furthermore, as used herein, the term “prompt” refers to any input, such as a query, question, or directive, provided to an AI assistant and/or a large language model (LLM) to elicit a response or action. Specifically, in some implementations, a prompt consists of text, keywords, or commands designed to direct the AI assistant and/or LLM to perform a particular task, such as generating text, summarizing information, answering a query related to specific documents or files, etc. For example, a prompt includes a request that the AI assistant and/or LLM summarize the content of a shared PDF document, retrieve information from a word processing document, analyze an image contained in the digital files of an organization, etc. In one or more embodiments, a prompt includes a pre-written prompt accessible to users or a subset of users within the organization for eliciting responses or actions such as those common to the users or to subsets of users.

Additionally, as used herein, the term “response” refers to an output or action generated by an AI assistant and/or LLM in reply to a given prompt. In particular, a response includes generated text, summaries, explanations, error messages or any other form of output that addresses the request or directive presented by the prompt. For instance, a response includes the AI assistant and/or LLM generating a summary of a digital document, providing an interpretation of data contained in a digital spreadsheet, offering a description based on the content of an image file, etc.

Further, as used herein, the term “error” refers to an incorrect output, failure, or unintended behavior produced by an AI assistant and/or LLM (e.g., the LLM based artificial intelligence assistant) in response to a given prompt. Specifically, an error occurs when the system generates inaccurate information, misinterprets a prompt, fails to perform the expected task, etc. To illustrate, an error involves the LLM based artificial intelligence assistant providing an incorrect document summary, misunderstanding a user's intent as reflected in a prompt, retrieving irrelevant documents for generating the response to the prompt, generating a response that conflicts with verified data, failing to perform a task etc.

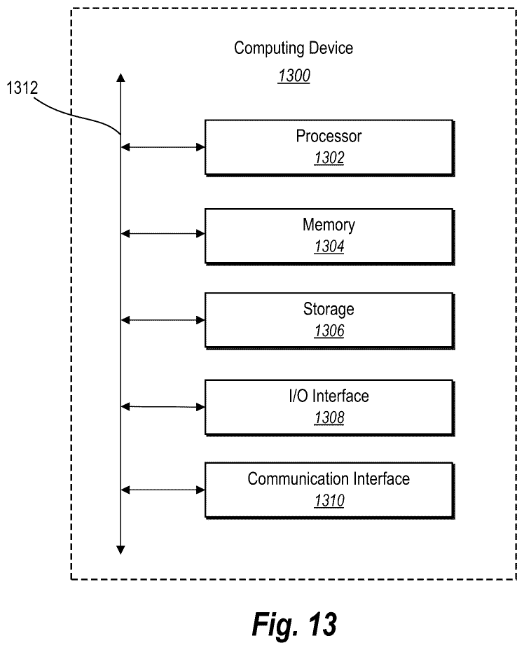

As used herein, the term “annotation tool” refers to a collection of devices that annotate digital data. Specifically, the annotation tool annotates digital data such as responses to prompts generated by an AI assistant and/or LLM (e.g., the LLM based artificial intelligence assistant) and/or the prompts themselves. For example, the annotation tool uses annotation devices to generate annotated responses for conveying error information associated with responses and/or prompts. Relatedly, the term “annotation device,” as used herein, refers to a computing device configured to annotate digital data. In particular, an annotation device includes a graphical user interface such as an annotation graphical user interface. For example, an annotation device utilizes the annotation graphical user interface to annotate digital data. In one or more implementations, an annotation device includes one or more of a variety of computing devices (including one or more computing devices as discussed in greater detail with relation to FIG. 13).

As used herein, the term “annotated response” refers to AI assistant and/or LLM generated responses and/or corresponding prompts annotated with error information. Specifically, an annotated response includes AI assistant and/or LLM generated responses and/or corresponding prompts with annotations identifying errors in the prompts and/or responses (e.g., error identification annotations). For instance, an annotated response includes error identification annotations which identify errors and provide a low level of detail (e.g., types of errors, etc.). Relatedly, the term “error identification annotation,” as used herein, refers to annotations that provide information identifying errors. Specifically, an error identification annotation includes indications as to various metrics of errors such as relevancy, consistency, completeness, groundedness, etc. For example, error identification annotations include indications as to whether a response is relevant to a corresponding prompt, internally consistent, complete in covering the subject matter and/or relevant documents, and/or grounded in information relevant to selected documents or other information sources.

As used herein, the term “error analysis mechanism” refers to a collection of devices that analyze errors. Specifically, the error analysis mechanism analyzes annotated responses to provide a higher level of detail for errors relative to the detail included in the annotated responses. For example, the error analysis mechanism uses reviewer devices to generate indications of errors providing the higher level of detail for the errors identified in the annotated responses. Relatedly, the term “reviewer device,” as used herein, refers to a computing device configured to review annotated responses. In particular, a reviewer device includes a graphical user interface such as an error graphical user interface. For example, a reviewer device utilizes the error graphical user interface to analyze the annotated responses. In some embodiments, a reviewer device includes one or more of a variety of computing devices (including one or more computing devices as discussed in greater detail with relation to FIG. 13).

Moreover, as used herein, the term “indication of error” (also referred to herein as “error indication”) refers to an error analysis data point providing high levels of detail. Specifically, an indication of an error conveys error information beyond the identification and general categorization of an error. For example, an indication of an error includes high detail analysis on relevance, groundedness, consistency, completeness, etc. of a response relative to the corresponding prompt and/or source data (e.g., in a digital document).

Furthermore, as used herein, the term “high-severity” refers to a particular error classification level. Specifically, high-severity refers to the appearance of correctness despite being incorrect. For example, an error in a response is classified as high-severity if an average user is unable to detect the error due to the error appearing to be correct.

Additionally, as used herein, the term “mid-severity” refers to a particular error classification level. Specifically, mid-severity refers to the appearance of incorrectness and an inability to recover. For example, an error in a response is classified as mid-severity if an average user is able to detect the error because the error appears to be incorrect, but such that a user cannot perform actions to recover from the error.

Further, as used herein, the term “low-severity” refers to a particular error classification level. Specifically, low-severity refers to the appearance of incorrectness and an ability to recover. For example, an error in a response is classified as low-severity if an average user is able to detect the error because the error appears to be incorrect and such a user can perform actions to recover from the error.

Moreover, as used herein, the term “hallucination” refers to any output generated by an AI assistant and/or LLM that is factually incorrect, fabricated, or not based on the input data or context thereof. Specifically, a hallucination includes responses that appear plausible but have no grounding in the provided/source documents, data, or knowledge base. For example, a hallucination includes a generated document summary that includes information not present in the actual file, etc.

Furthermore, as used herein, the term “engine” refers to a core software system or module that performs specific, essential functions within a larger application or platform. Specifically, an engine operates as the driving mechanism behind specialized tasks such as modifying a component of the LLM based artificial intelligence assistant. For example, an engine modifies components of the LLM based artificial intelligence assistant to improve generated responses and/or pre-written prompts of the LLM based artificial intelligence assistant.

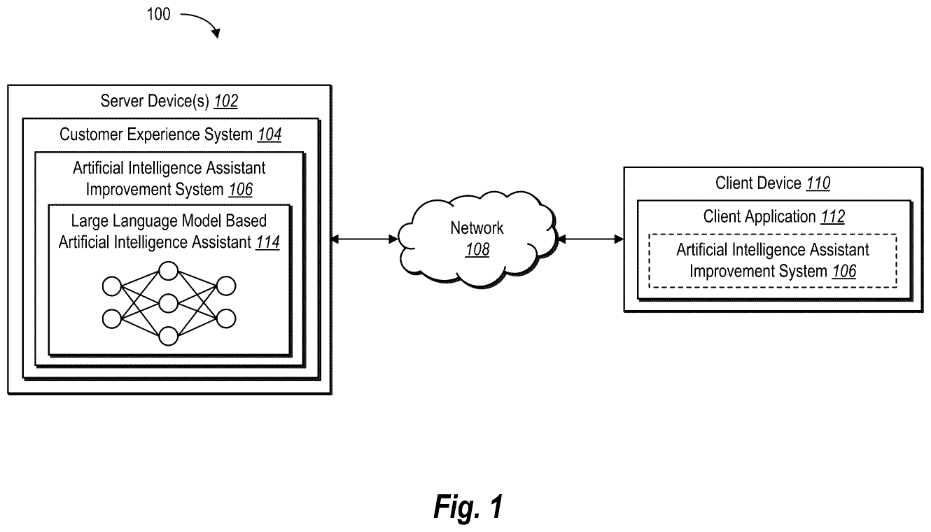

Additional detail regarding the AI assistant evaluation and improvement system 106 will now be provided with reference to the figures. For example, FIG. 1 illustrates a schematic diagram of an exemplary system 100 in which an AI assistant evaluation and improvement system 106 operates. As illustrated in FIG. 1, the system 100 includes a server device(s) 102, a network 108, and a client device 110. Although the system 100 of FIG. 1 is depicted as having a particular number of components, the system 100 is capable of having any number of additional or alternative components (e.g., any number of server devices, client devices, or other components in communication with the AI assistant evaluation and improvement system 106 via the network 108). Similarly, although FIG. 1 illustrates a particular arrangement of the server device(s) 102, the network 108, and the client device 110, various additional arrangements are possible.

The server device(s) 102, the network 108, and the client device 110 are communicatively coupled with each other either directly or indirectly (e.g., through the network 108 discussed in greater detail below in relation to FIG. 13). Moreover, the server device(s) 102 and the client device 110 include one or more of a variety of computing devices (including one or more computing devices as discussed in greater detail with relation to FIG. 13).

As mentioned above, the system 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server or a web-hosting server.

As shown, the server device(s) 102 includes a customer experience system 104. In one or more embodiments, the customer experience system 104 provides functionality by which a client device (e.g., the client device 110) views, generates, stores, and/or edits digital information, such as digital documents and/or a LLM interface chat. For example, in some instances, a client device sends a prompt to the customer experience system 104 hosted on the server device(s) 102 via the network 108. The customer experience system 104 then generates one or more responses to the prompts that the client device 110 accesses and views. For instance, in some cases, the customer experience system 104 provides one or more options that are usable by the client device to interact with an LLM based artificial intelligence assistant 114 to receive information and/or generate content.

As further shown, the server device(s) 102 also include the AI assistant evaluation and improvement system 106. In one or more embodiments, the AI assistant evaluation and improvement system 106 generates modifications to the LLM based artificial intelligence assistant 114 to improve the performance thereof when generating responses to prompts. In particular, as will be explained below, the AI assistant evaluation and improvement system 106 generates annotated responses, performs an error analysis on the errors identified in the annotated responses to generate error indications, classifies the errors based on the error indications. Additionally, in some implementations, the AI assistant evaluation and improvement system 106 generates the modifications to the LLM based artificial intelligence assistant 114 based on errors classified as high-severity due to the impact of such errors on users of the LLM based artificial intelligence assistant 114. By generating modifications to the LLM based artificial intelligence assistant 114, the AI assistant evaluation and improvement system 106 improves the performance of the LLM based artificial intelligence assistant 114 and therefore the user experience associated therewith.

As illustrated in FIG. 1, the AI assistant evaluation and improvement system 106 includes a large language model (LLM) based artificial intelligence assistant 114. Indeed, in these or other embodiments, the AI assistant evaluation and improvement system 106 implements the LLM based artificial intelligence assistant 114 to generate responses to prompts. In some cases, the LLM based artificial intelligence assistant 114 is external to the AI assistant evaluation and improvement system 106, but the AI assistant evaluation and improvement system 106 nevertheless accesses and utilizes the LLM based artificial intelligence assistant 114 via one or more plugins, APIs, or other network-based access protocols.

In one or more embodiments, the client device 110 includes a computing device that accesses, edits, segments, modifies, stores, and/or provides, for display, digital content such as an LLM dialogue of prompts and responses. For example, in some embodiments, the client device 110 includes a smartphone, a tablet, a desktop computer, a laptop computer, a head-mounted-display device, or another electronic device. In some instances, the client device 110 includes one or more applications (e.g., a client application 112) that access, edit, segment, modify, store, and/or provide, for display, digital content such as an LLM dialogue. For example, in one or more embodiments, the client application 112 includes a software application installed on the client device 110. Additionally, or alternatively, the client application 112 includes a web browser or other application that accesses a software application hosted on the server device(s) 102 (and supported by the customer experience system 104).

To provide an example implementation, in some embodiments, the AI assistant evaluation and improvement system 106 on the server device(s) 102 supports the AI assistant evaluation and improvement system 106 on the client device 110. For instance, in some cases, the AI assistant evaluation and improvement system 106 on the server device(s) 102 generates or learns parameters for the LLM based artificial intelligence assistant 114. The AI assistant evaluation and improvement system 106 then, via the server device(s) 102, provides the LLM based artificial intelligence assistant 114 to the client device 110. In other words, the client device 110 obtains (e.g., downloads) the LLM based artificial intelligence assistant 114 from the server device(s) 102. Once downloaded, the AI assistant evaluation and improvement system 106 on the client device 110 uses the LLM based artificial intelligence assistant 114 to generate an LLM dialogue including prompts and responses independent of the server device(s) 102.

In alternative implementations, the AI assistant evaluation and improvement system 106 includes a web hosting application that allows the client device 110 to interact with content and services hosted on the server device(s) 102. To illustrate, in one or more implementations, the client device 110 accesses a software application supported by the server device(s) 102. The client device 110 provides input to the server device(s) 102, such as a prompt. In response, the AI assistant evaluation and improvement system 106 on the server device(s) 102 generates a response. The server device(s) 102 then provides the response to the client device 110 for display.

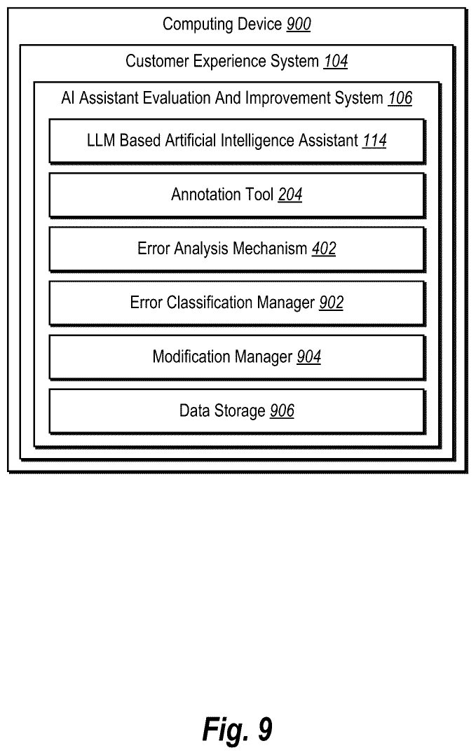

Although FIG. 1 illustrates the AI assistant evaluation and improvement system 106 implemented with regard to the server device(s) 102, different components of the AI assistant evaluation and improvement system 106 are able to be implemented by a variety of devices within the system 100. For example, in some instances, a different computing device (e.g., the client device 110) or a separate server from the server device(s) 102 implements one or more (or all) components of the AI assistant evaluation and improvement system 106. Indeed, as shown in FIG. 1, the client device 110 includes the AI assistant evaluation and improvement system 106. Example components of the AI assistant evaluation and improvement system 106 will be described below with regard to FIG. 9.

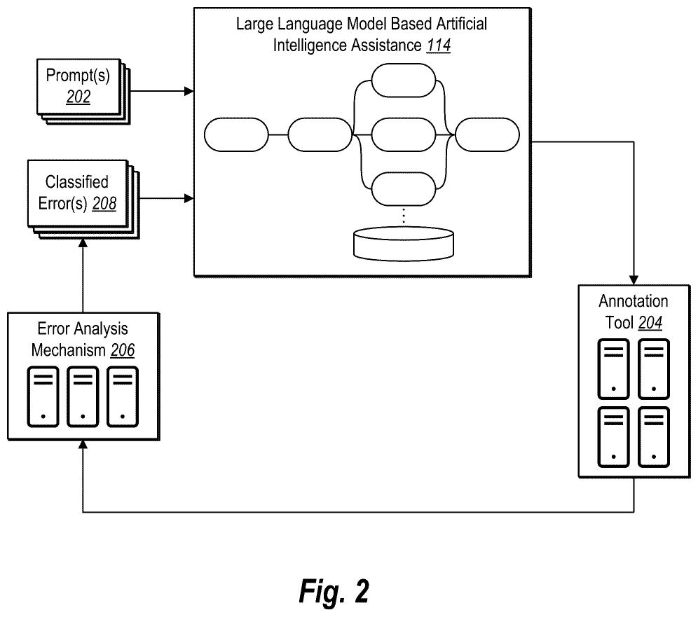

As previously noted, in one or more embodiments, the AI assistant evaluation and improvement system 106 continuously evaluates the performance of the LLM based artificial intelligence assistant and modifies the LLM based artificial intelligence assistant to resolve high-severity or other errors. For example, FIG. 2 illustrates the AI assistant evaluation and improvement system 106 utilizing an annotation tool 204 and an error analysis mechanism 206 to generate classified errors for modifying the LLM based artificial intelligence assistant.

As illustrated in FIG. 2, in one or more implementations, the AI assistant evaluation and improvement system 106 receives one or more prompts 202, such as from a client device user interface. Based on the prompts 202, the AI assistant evaluation and improvement system 106 utilizes the LLM based artificial intelligence assistant 114 to generate responses to the prompts 202. Based on these responses to the prompts 202, the AI assistant evaluation and improvement system 106 generates annotated responses.

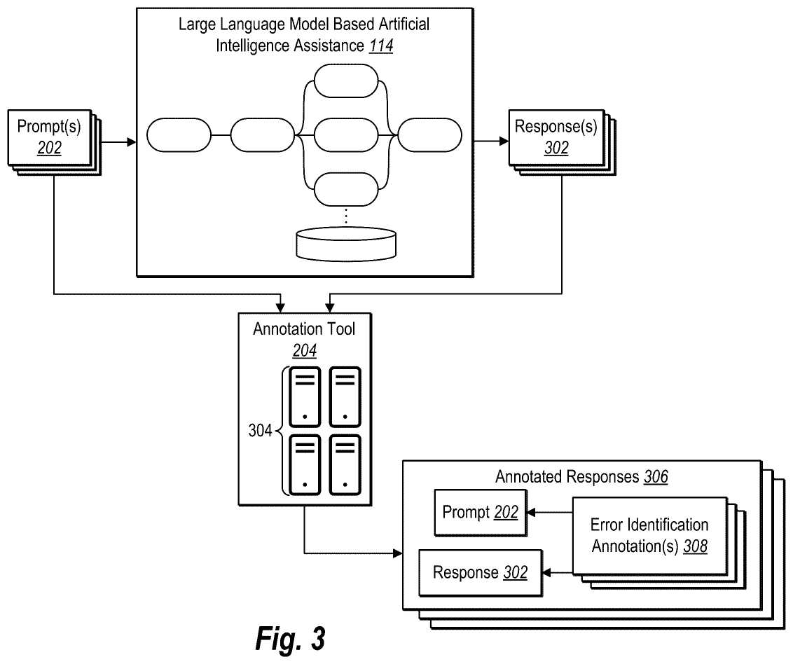

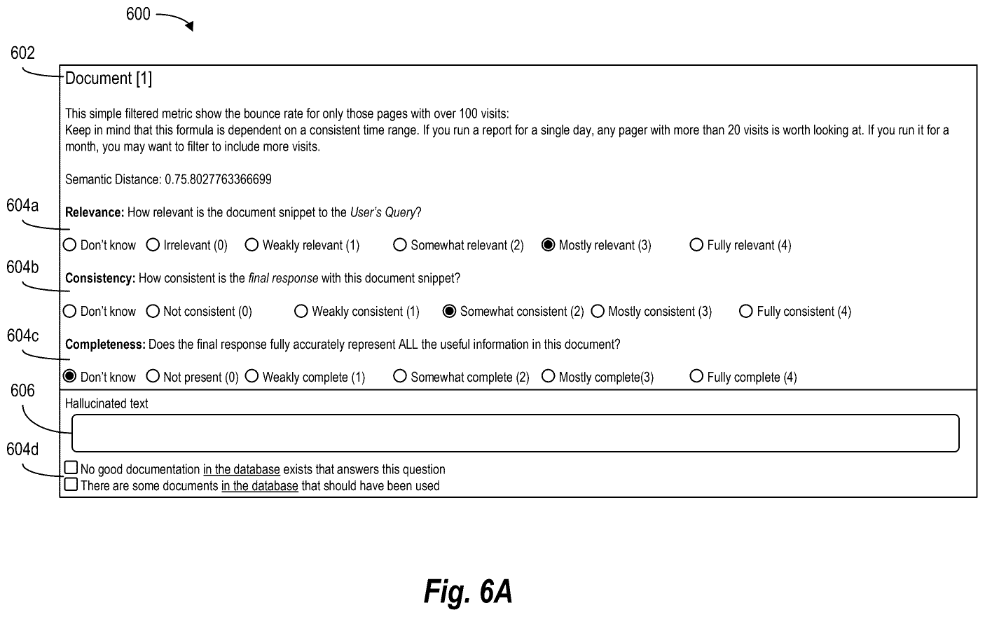

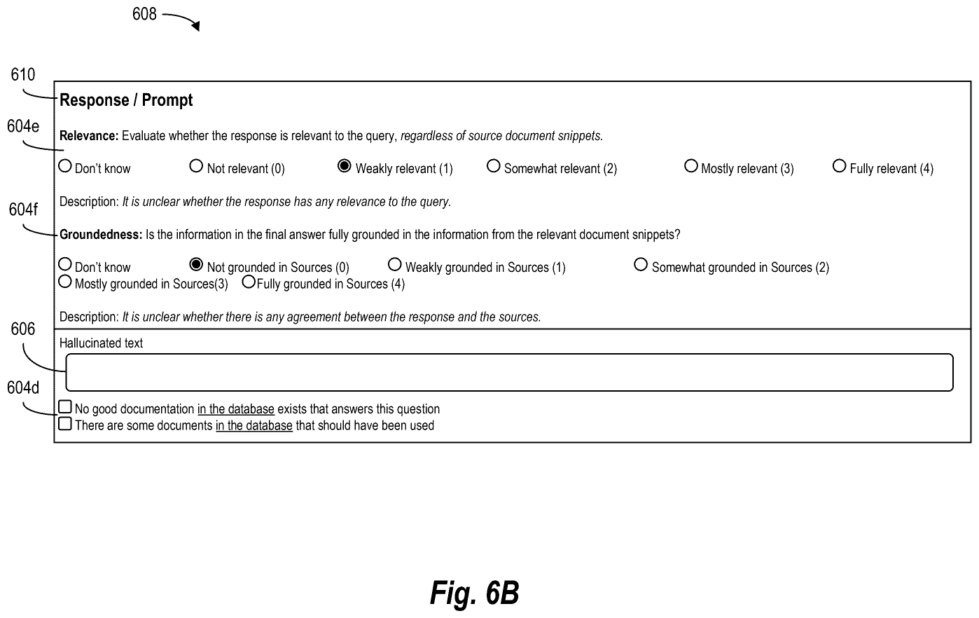

As further illustrated in FIG. 2 and as just mentioned, in some embodiments, the AI assistant evaluation and improvement system 106 generates annotated responses. In particular, the AI assistant evaluation and improvement system 106 generates the annotated responses using an annotation tool 204. For instance, the AI assistant evaluation and improvement system 106 utilizes annotation devices of the annotation tool 204 to modify the responses to generate the annotated responses as described in further detail with respect to FIG. 3. In some implementations, the AI assistant evaluation and improvement system 106 utilizes an annotation graphical user interface of the annotation tool to generate the annotated responses as described in further detail with respect to FIGS. 6A and 6B. Based on the annotated responses, the AI assistant evaluation and improvement system 106 generates indications of errors in the responses.

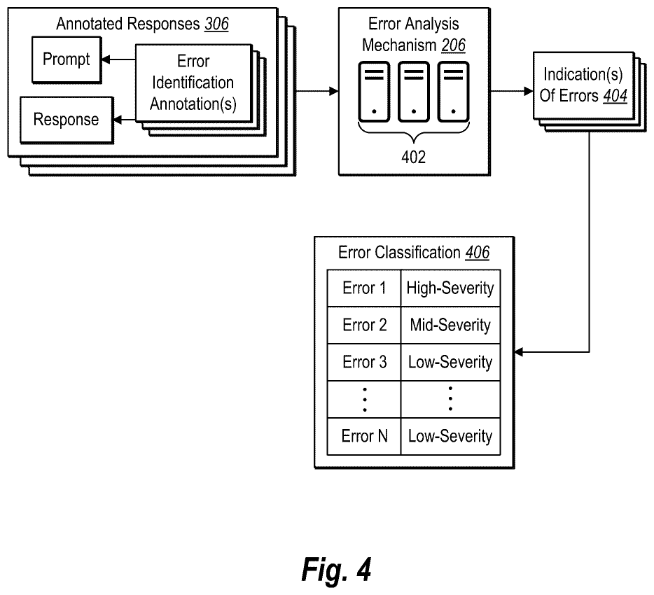

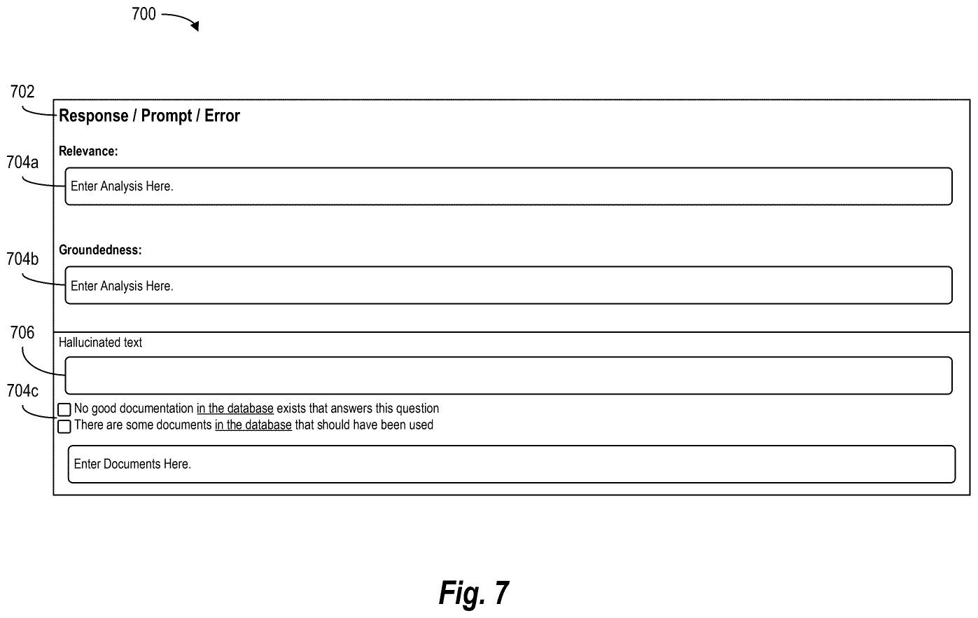

As additionally shown in FIG. 2 and as just mentioned, in one or more embodiments, the AI assistant evaluation and improvement system 106 generates indications of errors in the responses utilizing an error analysis mechanism 206. Specifically, the AI assistant evaluation and improvement system 106 utilizes one or more reviewer devices to generate the indications of the errors in the responses as described in further detail with respect to FIG. 4. In one or more implementations, the AI assistant evaluation and improvement system 106 utilizes an error graphical user interface of the error analysis mechanism to generate the indications of errors in the responses as described in further detail with respect to FIG. 7. Further, based on the errors indicated in the responses, the AI assistant evaluation and improvement system 106 classifies the errors.

As further illustrated in FIG. 2 and as just mentioned, in some embodiments, the AI assistant evaluation and improvement system 106 generates classified errors 208. In particular, the AI assistant evaluation and improvement system 106 classifies the errors based on the error indications from the error analysis mechanism 206 to determine priority errors as described in further detail with respect to FIG. 4. Moreover, based on the priority errors, the AI assistant evaluation and improvement system 106 modifies the LLM based artificial intelligence assistant 114.

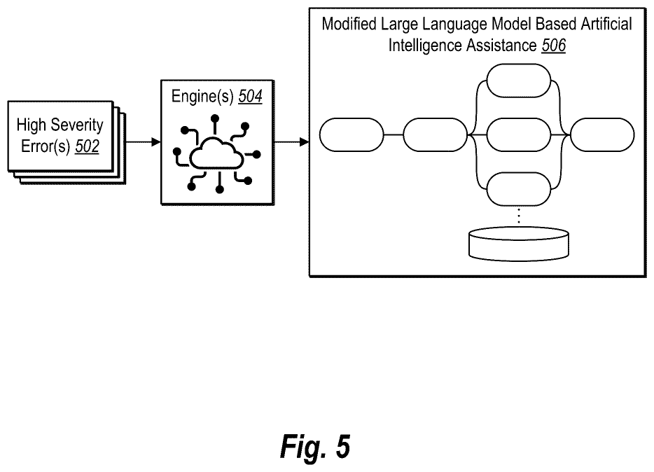

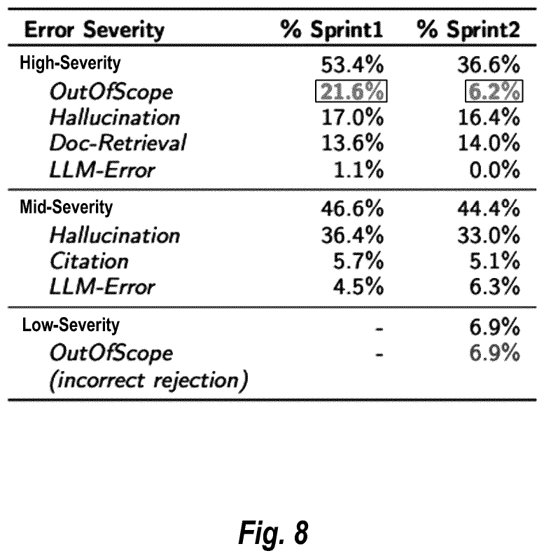

As also depicted in FIG. 2 and as just mentioned, in some implementations, the AI assistant evaluation and improvement system 106 modifies the LLM based artificial intelligence assistant 114 based on the classified errors 208. Specifically, the AI assistant evaluation and improvement system 106 modifies the LLM based artificial intelligence assistant 114 to improve the LLM based artificial intelligence assistant 114 as described in further detail with respect to FIG. 8. For example, the AI assistant evaluation and improvement system 106 utilizes one or more engines to modify one or more components of the LLM based artificial intelligence assistant 114 as described in further detail below with respect to FIG. 5.

In one or more embodiments, the AI assistant evaluation and improvement system 106 performs a step for determining a plurality of errors in the plurality of prompts. The above description of generating annotated responses via the annotation tool and generating indications of errors via the error analysis mechanism 206, including the supporting description of FIGS. 3-4, provide structure and support for acts of performing a step for determining a plurality of errors in the plurality of prompts.

For instance, as part of performing a step for determining a plurality of errors in the plurality of prompts, the AI assistant evaluation and improvement system 106 utilizes the prompts and responses generated by the LLM based artificial intelligence assistant 114 to generate the annotated responses via the annotation tool 204 (as described in the supporting description of FIG. 3). For example, the AI assistant evaluation and improvement system 106 utilizes annotation devices of the annotation tool 204 to generate error identification annotations and associate the error identification annotations with the prompts and/or responses. Also as part of performing a step for determining a plurality of errors in the plurality of prompts, the AI assistant evaluation and improvement system 106 generates indications of errors via the error analysis mechanism 206 (as described in the supporting description of FIG. 3). For example, the AI assistant evaluation and improvement system 106 generates indications of errors using the error analysis mechanism 206. Specifically, the AI assistant evaluation and improvement system 106 generates the indications of the errors based on the annotated responses generated by the annotation tool 204.

Furthermore, in one or more implementations, the AI assistant evaluation and improvement system 106 performs a step for classifying the plurality of errors as one of high-severity, mid-severity, or low-severity. The above description of generating classified errors 208, including the supporting description of FIG. 4, provide structure and support for acts and algorithms of performing a step for classifying the plurality of errors as one of high-severity, mid-severity, or low-severity.

For example, as part of performing a step for classifying the plurality of errors as one of high-severity, mid-severity, or low-severity, the AI assistant evaluation and improvement system 106 utilizes the indications of errors generated by the error analysis mechanism 206 to classify the plurality of errors (as described in the supporting description of FIG. 4). Specifically, the AI assistant evaluation and improvement system 106 categorizes the errors as one of high-severity, mid-severity, or low-severity based on a variety of factors as described in the supporting description of FIG. 4.

As mentioned above, in some embodiments, the AI assistant evaluation and improvement system 106 receives one or more prompts and generates annotated responses. Indeed, in some implementations, the AI assistant evaluation and improvement system 106 utilizes the annotation tool 204 to generate the annotated responses. FIG. 3 illustrates the AI assistant evaluation and improvement system 106 using the LLM based artificial intelligence assistant 114 and the annotation tool 204 to generate annotated responses in accordance with one or more embodiments.

As shown in FIG. 3, in one or more embodiments, the AI assistant evaluation and improvement system 106 receives one or more prompts 202 for generating responses 302 to the prompts 202. Specifically, in one or more implementations, the AI assistant evaluation and improvement system 106 receives the prompts 202 from one or more graphical user interfaces. For example, the AI assistant evaluation and improvement system 106 receives prompts 202 via an AI assistant graphical user interface. In these or other embodiments, the AI assistant evaluation and improvement system 106 generates or utilizes an AI assistant graphical user interface for the LLM based artificial intelligence assistant 114. Indeed, in some embodiments, the AI assistant evaluation and improvement system 106 receives the prompts 202 via the AI assistant graphical user interface for the LLM based artificial intelligence assistant 114.

As further illustrated in FIG. 3, in some implementations, the AI assistant evaluation and improvement system 106 generates responses 302 to the prompts 202. In particular, the AI assistant evaluation and improvement system 106 uses the LLM based artificial intelligence assistant 114 to generate the responses 302 to the prompts 202. For instance, in one or more embodiments, the AI assistant evaluation and improvement system 106 generates at least one response 302 for each prompt 202. Additionally, the AI assistant evaluation and improvement system 106 determines errors in the responses 302 and/or prompts 202. For example, in one or more implementations, the AI assistant evaluation and improvement system 106 determines errors in the responses 302 and/or prompts 202 through a series of actions including using an annotation tool 204 to generate annotated responses 306. While some responses 302 do not include errors, the AI assistant evaluation and improvement system 106 determines one or more errors in the responses 302 that include one or more errors.

As additionally shown in FIG. 3, in some embodiments, the AI assistant evaluation and improvement system 106 provides the prompts 202 and/or the responses 302 to the annotation tool 204. Specifically, the AI assistant evaluation and improvement system 106 provides the prompts 202 and/or the responses 302 to one or more annotation devices 304 of the annotation tool 204. For example, the AI assistant evaluation and improvement system 106 provides the prompts 202 and/or the responses 302 to the annotation devices 304 via an annotation graphical user interface. In some implementations, the AI assistant evaluation and improvement system 106 provides the prompts 202 and/or responses 302 as masked data (i.e., to protect confidential or otherwise sensitive information within the prompts 202 and responses 302). Further, in one or more embodiments, the AI assistant evaluation and improvement system 106 utilizes the annotation devices 304 of the annotation tool 204 to generate the annotated responses 306.

As further illustrated in FIG. 3 and as just mentioned, in one or more implementations, the AI assistant evaluation and improvement system 106 generates the annotated responses 306 using the annotation tool 204. In particular, the AI assistant evaluation and improvement system 106 generates the annotated responses 306 by modifying the prompts 202 and/or the responses 302. For instance, the AI assistant evaluation and improvement system 106 modifies the prompts 202 and/or the responses 302 by adding error identification annotations 308 to the prompts 202 and/or the responses.

As also depicted in FIG. 3, in some embodiments, the AI assistant evaluation and improvement system 106 generates the annotated responses 306 comprising error identification annotations 308 by adding the error identification annotations 308 to the prompts 202 and/or responses 302. Specifically, the AI assistant evaluation and improvement system 106 generates the error identification annotations 308 via an annotation graphical user interface. For example, the AI assistant evaluation and improvement system 106 generates an annotation graphical user interface for display on the annotation devices 304 to generate the error identification annotations 308. In these or other embodiments, the AI assistant evaluation and improvement system 106 generates annotation graphical user interfaces as shown and described in further detail with respect to FIGS. 6A and 6B.

As further illustrated in FIG. 3, in some implementations, the AI assistant evaluation and improvement system 106 utilizes the annotation graphical user interface of the annotation devices 304 to generate the error identification annotations 308 for specific errors. For example, the AI assistant evaluation and improvement system 106 utilizes the annotation graphical user interface to identify errors within the responses 302 and/or corresponding prompts 202. To illustrate, the annotation tool 204 generates an annotated response 306 by identifying one or more errors in a response 302 and/or a corresponding prompt 202. In these or other embodiments, the annotation tool 204 generates one or more error identification annotations 308 for the error in the response 302 and/or prompt 202. Moreover, in one or more embodiments, the AI assistant evaluation and improvement system 106 associates the error identification annotations 308 with the response 302 and/or corresponding prompt 202 to generate the annotated responses 306. In one or more implementations, the AI assistant evaluation and improvement system 106 generates the error identification annotations 308 to include a low level of detail regarding the identified errors. Additional detail regarding the low level of detail for the identified errors in the error identification annotations 308 is included with respect to FIGS. 6A and 6B.

Further, in some embodiments, the AI assistant evaluation and improvement system 106 generates error identification annotations 308 for a response 302 and corresponding prompt 202 using multiple annotation devices 304. For example, the AI assistant evaluation and improvement system 106 generates annotated responses 306 for a single response 302 and/or corresponding prompt from multiple annotation devices 304 to improve the quality and comprehensiveness of the annotated responses 306 for each error of a response 302 and/or prompt 202.

Furthermore, in some implementations, the AI assistant evaluation and improvement system 106 utilizes the annotation tool 204 to generate annotated responses 306 for the LLM based artificial intelligence assistant 114 as a whole and/or for the individual components of the LLM based artificial intelligence assistant 114. For example, in one or more embodiments, the AI assistant evaluation and improvement system 106 generates annotated responses 306 to evaluate the performance of the LLM based artificial intelligence assistant 114 as a whole. Additionally, in one or more implementations, the AI assistant evaluation and improvement system 106 generates annotated responses 306 to evaluate the performance of the individual components of the LLM based artificial intelligence assistant 114 such as a prompt rewrite component, an intent detection component, a data quality assurance pipeline, a concepts quality assurance pipeline, an out-of-scope pipeline, an response generation component, a chat history/user session database, a documentation collection, or an AI assistant graphical user interface.

Additionally, in some embodiments, by generating annotated responses 306 based on prior interactions the AI assistant evaluation and improvement system 106 generates multiple innovative error metrics. In these or other embodiments, the AI assistant evaluation and improvement system 106 generates the annotated responses 306 based on prior interaction such as the responses 302, prompts 202 corresponding to responses 302, chat history comprising a chat session of prompts 202 and responses 302, etc. Further, in these or other embodiments, the AI assistant evaluation and improvement system 106 generates multiple innovative error metrics such as error metrics by severity and golden-labeled data for model improvements. For example, the AI assistant evaluation and improvement system 106 generates error metrics by severity by comparing the annotated responses 306 to decisions the AI assistant evaluation and improvement system 106 made when generating the responses 302. Moreover, the AI assistant evaluation and improvement system 106 generates golden-labeled data for improving the LLM based artificial intelligence assistant 114 and/or individual components thereof via modifications as described in further detail with respect to FIG. 5.

As noted above, in some implementations, the AI assistant evaluation and improvement system 106 generates indications of errors in the responses and classifies the errors. Indeed, in one or more embodiments, the AI assistant evaluation and improvement system 106 generates classifies errors in responses based on the indications of errors. FIG. 4 illustrates the AI assistant evaluation and improvement system 106 generating indications of errors in responses and classifying the severity of the errors in accordance with one or more embodiments.

As portrayed in FIG. 4, in one or more implementations, the AI assistant evaluation and improvement system 106 provides the annotated responses 306 to an error analysis mechanism 206. As mentioned previously, in some embodiments, the AI assistant evaluation and improvement system 106 determines errors in the responses and/or prompts through a series of actions. For example, the AI assistant evaluation and improvement system 106 determines errors in the responses and/or prompts by providing the annotated responses 306 to the error analysis mechanism 206. Specifically, the AI assistant evaluation and improvement system 106 provides the annotated responses 306 to one or more reviewer devices 402 of the error analysis mechanism 206. For example, the AI assistant evaluation and improvement system 106 provides the annotated responses 306 to the reviewer devices 402 of the error analysis mechanism 206 via an error graphical user interface. In these or other embodiments, the AI assistant evaluation and improvement system 106 provides the annotated responses 306 via error graphical user interfaces such as the exemplary error graphical user interface of FIG. 7.

As additionally shown in FIG. 4, in some implementations, the AI assistant evaluation and improvement system 106 generates indications of errors 404 based on the annotated responses 306. In particular, the AI assistant evaluation and improvement system 106 receives indications of errors 404 for the prompts and/or responses from the reviewer devices 402. For instance, the AI assistant evaluation and improvement system 106 receives the indications of the errors 404 from the reviewer devices 402 via the error graphical user interface. Additional detail as to the indications of errors 404 that the AI assistant evaluation and improvement system 106 receives is provided with respect to FIG. 7. In general, in one or more embodiments, the AI assistant evaluation and improvement system 106 generates the indications of the errors 404 to provide a high level of detail of the errors.

In one or more implementations, the AI assistant evaluation and improvement system 106 utilizes few reviewer devices 402 in the error analysis mechanism 206 by comparison with the number of annotation devices 304 of the annotation tool 204. For example, as shown in FIG. 4, the error analysis mechanism 206 includes three reviewer devices 402 compared to the four annotation devices 304 of the annotation tool 204 depicted in FIG. 3. In some embodiments, the AI assistant evaluation and improvement system 106 utilizes significantly fewer reviewer devices 402 in comparison with the number of annotation devices 304 such as a 1:2 ratio, 1:5 ratio, or 1:10 ratio. By doing so, the AI assistant evaluation and improvement system 106 reduces the computing resources required to generate the indications of errors 404. For example, while each annotation device 304 provides a low level of detail in the annotated responses 306, in the aggregate, a large number of annotation devices 304 provide more robust information regarding the errors by generating many annotated responses 306. Indeed, the many annotated responses 306 include repetitive annotated responses 306 (multiplicated for a single response/error pair), thereby providing more robust information regarding the errors. The AI assistant evaluation and improvement system 106 then utilizes the error analysis mechanism 206 and its fewer number of reviewer devices to provide higher levels of detail for the errors based on the annotated responses 306, thereby preserving computing resources required to generate high levels of detail for errors in the prompts and/or responses.

As further illustrated in FIG. 4, in some implementations, the AI assistant evaluation and improvement system 106 classifies the errors (or generates an error classification 406 of the errors) based on the indications of the errors 404. Specifically, based on the indications of the errors 404, the AI assistant evaluation and improvement system 106 classifies each error as having a particular severity level. For example, in one or more embodiments, the AI assistant evaluation and improvement system 106 classifies each error as one of high-severity, mid-severity, or low-severity. To illustrate, as shown in FIG. 4, the AI assistant evaluation and improvement system 106 classifies a first error (error 1) as high-severity, a second error (error 2) as mid-severity, and a third error (error 3) as low-severity. In these or other embodiments, the AI assistant evaluation and improvement system 106 classifies all the errors (e.g., Error 1-Error N) identified by the AI assistant evaluation and improvement system 106 through the annotation tool 204 and/or the error analysis mechanism 206.

As noted previously, in one or more implementations, the AI assistant evaluation and improvement system 106 classifies errors as high-severity based on the indications of the errors 404. Specifically, the AI assistant evaluation and improvement system 106 classifies errors as high-severity by determining that a response appears correct but is incorrect. For example, the AI assistant evaluation and improvement system 106 determines that a response appears correct based on a threshold of familiarity with the subject matter of the response, the corresponding prompt, and/or the digital documents or other source information. To illustrate, the AI assistant evaluation and improvement system 106 determines that a response appears correct based on the familiarity of an average user of the LLM based artificial intelligence assistant 114 with the subject matter. In some embodiments, the AI assistant evaluation and improvement system 106 classifies errors as high-severity based on a variety of other indicia as well.

As just mentioned, in some implementations, the AI assistant evaluation and improvement system 106 classifies errors as high-severity based on a variety of indicia. For example, in one or more embodiments, the AI assistant evaluation and improvement system 106 classifies an error as high-severity by determining that a response includes a hallucination. In these or other embodiments, the AI assistant evaluation and improvement system 106 classifies the error as high-severity rather than mid-severity or low-severity based on the response including the hallucination. In particular, the AI assistant evaluation and improvement system 106 does so by determining that the hallucination includes a logical consistency, such as a logical consistency with other accurate information in the response or accurate information known to a user meeting the threshold familiarity with the subject matter. Furthermore, in one or more implementations, the AI assistant evaluation and improvement system 106 classifies the error as high-severity by determining that the hallucination includes a persuasive concept to a user meeting the threshold familiarity with the subject matter or otherwise incorrect data that cannot easily be independently verified by such a user.

Additionally, in some embodiments, the AI assistant evaluation and improvement system 106 classifies errors as mid-severity based on the indications of the errors 404. Specifically, the AI assistant evaluation and improvement system 106 classifies errors as mid-severity by determining that a response appears incorrect and cannot be corrected. For example, in some implementations, the AI assistant evaluation and improvement system 106 generates a response that appears incorrect to a user meeting a threshold familiarity with the subject matter, such as by including a logical inconsistency, an unpersuasive concept, or information that is easily independently verified by such a user. Further, in these or other embodiments, the AI assistant evaluation and improvement system 106 determines that neither the AI assistant evaluation and improvement system 106 nor the LLM based artificial intelligence assistant 114 provide a method of correcting (or recovering from) the error. To illustrate, in one or more embodiments, the AI assistant evaluation and improvement system 106 classifies an error as mid-severity by determining that the response includes a non-overridable error message.

Moreover, in one or more implementations, the AI assistant evaluation and improvement system 106 classifies errors as low-severity based on the indications of the errors 404 as well. Specifically, the AI assistant evaluation and improvement system 106 classifies errors as low-severity by determining that the response appears incorrect by including logical inconsistencies, information not responsive to the prompt corresponding to the response (i.e., the prompt used to generate the response), etc. as just described with respect to errors classified as mid-severity. In contrast to errors classified as mid-severity, however, the AI assistant evaluation and improvement system 106 classifies errors as low-severity by also determining that a response can be corrected. For example, the AI assistant evaluation and improvement system 106 determines that the LLM based artificial intelligence assistant 114 includes a method for resolving the error such as by allowing the submission of a rephrased prompt or by generating an overridable error message.

As previously mentioned, in some embodiments, the AI assistant evaluation and improvement system 106 modifies the LLM based artificial intelligence assistant based on the classified errors. Indeed, in some implementations, the AI assistant evaluation and improvement system 106 utilizes one or more engines to modify the LLM based artificial intelligence assistant. FIG. 5 illustrates the AI assistant evaluation and improvement system 106 utilizing one or more engines to modify the LLM based artificial intelligence assistant in accordance with one or more embodiments.

As depicted in FIG. 5, in one or more embodiments, the AI assistant evaluation and improvement system 106 generates modifications to the LLM based artificial intelligence assistant 114 based on one or more high-severity errors 502. Specifically, the AI assistant evaluation and improvement system 106 generates a modification to the LLM based artificial intelligence assistant 114 that addresses the one or more high-severity errors 502 (i.e., errors classified as high-severity) or other errors. For example, the AI assistant evaluation and improvement system 106 generates modifications to one or more of the components of the LLM based artificial intelligence assistant 114 to address the high-severity errors 502 first and then other errors. Furthermore, in one or more implementations, the AI assistant evaluation and improvement system 106 generates the modifications using one or more engines 504.

As also depicted in FIG. 5 and as just mentioned, in some embodiments, the AI assistant evaluation and improvement system 106 uses engines 504 to generate the modifications to the LLM based artificial intelligence assistant 114. In particular, the AI assistant evaluation and improvement system 106 includes a variety of engines 504 such as a user experience design engine, a prompt improvement engine, an in-house model generation engine, a synthetic data template engine, and/or a data index optimization engine. In some implementations, the AI assistant evaluation and improvement system 106 utilizes one or more of these engines 504 to generate a modification to the LLM based artificial intelligence assistant 114 resulting in a modified LLM based artificial intelligence assistant 506. In these or other embodiments, the AI assistant evaluation and improvement system 106 utilizes the engines 504 to generate modifications to one or more of the components of the LLM based artificial intelligence assistant 114 including components such as a prompt rewrite component, an intent detection component, a data quality assurance pipeline, a concepts quality assurance pipeline, an out-of-scope pipeline, a response generation component, a chat history/user session database, a documentation collection, an AI assistant graphical user interface, etc.

In one or more embodiments, the modifications include a variety of potential improvements or changes to the components of the LLM based artificial intelligence assistant 114. To illustrate, in one or more implementations, the AI assistant evaluation and improvement system 106 utilizes a user experience design engine to modify the appearance and/or content of the various graphical user interfaces such as the AI assistant graphical user interface, the annotation graphical user interface, the error graphical user interface, etc. Additionally, in some embodiments, the AI assistant evaluation and improvement system 106 utilizes the prompt improvement engine to generate a modification to the prompt rewrite component and/or the intent detection component for improvement and engineering of prompts (e.g., pre-written prompts) to improve the responses that the LLM based artificial intelligence assistant 114 generates. Further, in some implementations, the AI assistant evaluation and improvement system 106 utilizes an in-house model generation engine to modify a response generation component for improvement of responses that the LLM based artificial intelligence assistant 114 generates. Moreover, in one or more embodiments, the AI assistant evaluation and improvement system 106 uses a synthetic data template engine to create new templates and patterns for synthetic data that AI assistant evaluation and improvement system 106 uses for benchmarking the performance of the LLM based artificial intelligence assistant 114. Furthermore, in one or more implementations, the AI assistant evaluation and improvement system 106 uses a data index optimization engine to generate a modification such as optimizing the specialized data indexes that the LLM based artificial intelligence assistant 114 queries to generate responses.

In some embodiments, the AI assistant evaluation and improvement system 106 utilizes the annotated responses 306 generated by the annotation tool 204 to train an annotation LLM. In these or other embodiments, the AI assistant evaluation and improvement system 106 utilizes the annotation LLM to replace or supplement the annotation tool 204. In these or other embodiments, the AI assistant evaluation and improvement system 106 provides the prompts 202 and the responses 302 to the annotation LLM to generate the annotated responses 306 or additional annotated responses 306. In some implementations, in addition to the responses 302 and/or the prompts 202, the AI assistant evaluation and improvement system 106 provides the source information, such as digital documents, used to generate the responses 302 to the annotation LLM for generating the annotated responses 306. In one or more embodiments, the AI assistant evaluation and improvement system 106 utilizes the annotated responses 306 generated by the annotation LLM to modify the LLM based artificial intelligence assistant 114. For example, the AI assistant evaluation and improvement system 106 utilizes these annotation LLM generated annotated responses 306 to generate modifications to the components of the LLM based artificial intelligence assistant 114. In one or more implementations, such modifications to the LLM based artificial intelligence assistant 114 include small scale maintenance modifications and/or alpha testing of new capabilities of the LLM based artificial intelligence assistant 114. For example, in these or other embodiments, the LLM based artificial intelligence assistant 114 generates responses based on changes to the LLM based artificial intelligence assistant 114 representing new capabilities and uses the annotation LLM to generate annotated responses 306 for the responses generated with the new capabilities. The AI assistant evaluation and improvement system 106 then incorporates these annotated responses 306 to assess the new capabilities of the LLM based artificial intelligence assistant 114.

As previously noted, in some embodiments, the AI assistant evaluation and improvement system 106 utilizes an annotation graphical user interface of the annotation tool to generate the annotated responses. FIGS. 6A and 6B illustrate exemplary annotation graphical user interfaces in accordance with one or more embodiments.

As illustrated in FIG. 6A, in some implementations, the AI assistant evaluation and improvement system 106 generates an annotation graphical user interface 600 for generating annotated responses. Specifically, the AI assistant evaluation and improvement system 106 utilizes the annotation graphical user interface 600 to generate the error identification annotations 308 of the annotated responses 306 as described above with respect to FIG. 3. For example, as mentioned above with respect to FIG. 3, the AI assistant evaluation and improvement system 106 generates the error identification annotations 308 to include a low level of detail regarding the identified errors. In these or other embodiments, the AI assistant evaluation and improvement system 106 utilizes various elements of the annotation graphical user interface 600 to generate the error identification annotations 308.

Additionally, in one or more embodiments, the AI assistant evaluation and improvement system 106 generates the error identification annotations 308 to include information regarding specific digital documents or other sources used to generate the responses. For example, the AI assistant evaluation and improvement system 106 generates these error identification annotations 308 for specific digital documents as referenced by a document identification element 602.

As further illustrated in FIG. 6A, in one or more implementations, the AI assistant evaluation and improvement system 106 utilizes annotation elements 604 to generate the error identification annotations 308 to include low level details of the identified errors. In some embodiments, the annotation elements 604 include rating scales (e.g., categorical scales such as Likert scales) for generating the error identification annotations 308 as shown for annotation elements 604a-c and 604e-f. Further, in some implementations, the AI assistant evaluation and improvement system 106 generates the error identification annotations 308 to include low level details such as whether and how much the document indicated in the document identification element 602, or a snippet thereof, is relevant to a prompt. For example, in one or more embodiments, the AI assistant evaluation and improvement system 106 uses an annotation element 604a to generate low level relevancy information, such as by determining whether and/or how much the document, or document snippet, is irrelevant, weakly relevant, somewhat relevant, mostly relevant, or fully relevant to the prompt based on an input to the annotation element 604a.

As just described with respect to the annotation element 604a, the AI assistant evaluation and improvement system 106 utilizes an annotation element 604b and an annotation element 604c to generate low level consistency and completeness information, respectively, for the document, or document snippet, and/or the response. Specifically, in one or more implementations, the AI assistant evaluation and improvement system 106 uses the annotation element 604b to determine whether and/or how much the document, or snippet thereof, is consistent with the response. Additionally, in some embodiments, the AI assistant evaluation and improvement system 106 uses the annotation element 604c to determine whether and/or how much the response fully or accurately represents the useful information in the document, or snippet thereof.

Moreover, in some implementations, the AI assistant evaluation and improvement system 106 uses the annotation graphical user interface 600 to generate the error identification annotations 308 to include low level information for a prompt such as whether a database includes documents relevant to a prompt. For example, the AI assistant evaluation and improvement system 106 utilizes an annotation element 604d to determine whether a database used by the LLM based artificial intelligence assistant 114 includes digital documents or information relevant to a prompt. To illustrate, as shown in FIG. 6A, the AI assistant evaluation and improvement system 106 utilizes one or more checkboxes (or other user interface input elements) to generate an error identification annotation 308 indicating that the database does not include digital documents and/or information in the database that answers the prompt or that the database does include such documents.

Furthermore, in one or more embodiments, the AI assistant evaluation and improvement system 106 uses the annotation graphical user interface 600 to generate the error identification annotations 308 to include an indication of a hallucination. For example, the AI assistant evaluation and improvement system 106 utilizes a hallucination element 606 to determine text included within the response that is, or may be, a hallucination. In one or more implementations, the hallucination element 606 includes a text input box that the AI assistant evaluation and improvement system 106 uses to determine the hallucinated text.

As noted above, FIG. 6B illustrates an exemplary annotation graphical user interface in accordance with one or more embodiments. In some embodiments, the AI assistant evaluation and improvement system 106 generates an annotation graphical user interface 608 for generating annotated responses as described above with respect to FIG. 3. Similar to the annotation graphical user interface 600, the AI assistant evaluation and improvement system 106 uses the annotation graphical user interface 608 to generate the error identification annotations 308 to include low level details regarding the identified errors via various elements of the annotation graphical user interface 608. For example, the AI assistant evaluation and improvement system 106 generates these error identification annotations 308 for specific responses or prompts as referenced by a response/prompt identification element 610.

As shown in FIG. 6B, in some implementations, the AI assistant evaluation and improvement system 106 uses the elements of the annotation graphical user interface 608 to generate the error identification annotations 308 to include information regarding a response generated by the LLM based artificial intelligence assistant 114 and/or a corresponding prompt. Specifically, the AI assistant evaluation and improvement system 106 generates the annotation graphical user interface 608 to include annotation elements 604, such as annotation elements 604e-f. As mentioned previously, in one or more embodiments, the annotation elements 604e-f include rating scales as shown in FIG. 6B. In these or other embodiments, the AI assistant evaluation and improvement system 106 uses these annotation element rating scales in a similar manner as described above with respect to FIG. 6A.

As additionally shown in FIG. 6B, in one or more implementations, the AI assistant evaluation and improvement system 106 uses the annotation element 604e to generate error identification annotations 308 indicating error information such as whether and how much the response is relevant to the prompt. In these or other embodiments, the AI assistant evaluation and improvement system 106 generates this relevance information for inclusion in the error identification annotations 308 regardless of source digital documents, or snippets thereof, from a database. Similarly, in some embodiments, the AI assistant evaluation and improvement system 106 uses the annotation element 604f to determine groundedness of the response in the digital documents or other source information. Specifically, the AI assistant evaluation and improvement system 106 determines whether and/or how much the response is grounded in the digital documents and/or other source information that the LLM based artificial intelligence assistant 114 determines to be relevant to the prompt.

As further illustrated in FIG. 6B, in some implementations, the AI assistant evaluation and improvement system 106 determines hallucination text included in the response. Specifically, the AI assistant evaluation and improvement system 106 determines the hallucination text using the hallucination element 606 as described above with respect to FIG. 6A. Additionally, in one or more embodiments, the AI assistant evaluation and improvement system 106 determines whether a database used by the LLM based artificial intelligence assistant 114 includes digital documents or information relevant to a prompt. In particular, the AI assistant evaluation and improvement system 106 does so by utilizing the annotation element 604d as described above with respect to FIG. 6A. Further, in one or more implementations, the AI assistant evaluation and improvement system 106 utilize annotation elements as described above to determine whether the error is one of non-response, such as in cases where the response includes an error message.

As noted previously, in some embodiments, the AI assistant evaluation and improvement system 106 generates error identification annotations 308 for specific prompts as referenced by the response/prompt identification element 610. Moreover, in some implementations, the error identification annotations 308 indicate whether and what type of errors a prompt includes. For example, the error identification annotations 308 indicate whether the prompt includes ambiguities or overgeneralizations causing the LLM based artificial intelligence assistant 114 to misinterpret the intent of the prompt or failing to provide sufficient direction to the LLM based artificial intelligence assistant. Furthermore, in one or more embodiments, the error identification annotations 308 indicate whether the prompt lacks specificity or is overcomplex resulting in the LLM based artificial intelligence assistant 114 having difficulty providing appropriate or complete information or parsing the content of the prompt. Additionally, in one or more implementations, the error identification annotations 308 indicate whether the prompt is overly long, includes misleading information or misspellings, etc.

As previously mentioned, in some embodiments, the AI assistant evaluation and improvement system 106 utilizes an error graphical user interface of the error analysis mechanism to generate the indications of errors in the responses. FIG. 7 illustrates an exemplary error graphical user interface in accordance with one or more embodiments.

As portrayed in FIG. 7, in some implementations, the AI assistant evaluation and improvement system 106 generates an error graphical user interface 700 for generating indications of errors (error indications). Specifically, the AI assistant evaluation and improvement system 106 uses the error graphical user interface 700 to generate the error indications to include a high level of detail regarding the errors that the annotation tool identifies. In these or other embodiments, the AI assistant evaluation and improvement system 106 utilizes various elements of the error graphical user interface 700 to generate the error indications. For instance, the AI assistant evaluation and improvement system 106 generates the error indications for specific responses, prompts, errors, error types, etc. as referenced by a response/prompt/error element 702.

As also depicted in FIG. 7 and as previously noted, in one or more embodiments, the AI assistant evaluation and improvement system 106 uses various elements of the error graphical user interface 700 to generate the error indications. Specifically, the AI assistant evaluation and improvement system 106 uses error elements 704 to generate the error indications to include a high level of detail the errors identified in the annotated responses. For example, based on the annotated responses, the AI assistant evaluation and improvement system 106 uses the error elements 704 to generate error indications that provide details such as patterns of errors, probable causes for the errors/error patterns, and/or specific improvements to the LLM based artificial intelligence assistant 114 and/or AI assistant evaluation and improvement system.

To illustrate, as further illustrated in FIG. 7, in one or more implementations, the AI assistant evaluation and improvement system 106 uses error elements 704 to determine a higher level of detail for similar error metrics determined in the error identification annotations 308 of the annotated errors such as relevance, groundedness, etc. as described above with respect to FIGS. 6A and 6B. For instance, in some embodiments, the AI assistant evaluation and improvement system 106 uses an error element 704a to generate greater detail regarding the relevance of documents, or snippets thereof, to prompts, the relevance of responses to prompts, and/or error patterns, probable causes for the errors/error patterns, and or specific improvements as mentioned above. For example, the AI assistant evaluation and improvement system 106 generates the error element 704a to include an input text element. In these or other embodiments, the AI assistant evaluation and improvement system 106 receives the higher level of detail regarding relevance of documents, or snippets thereof, to prompts, the relevance of responses to prompts, and/or error patterns, probable causes for the errors/error patterns, and or specific improvements.

As additionally shown in FIG. 7, in some implementations, the AI assistant evaluation and improvement system 106 generates greater detail regarding the groundedness of responses in the prompts, error patterns associated therewith, probable causes for the errors/error patterns, and or specific improvements to the LLM based artificial intelligence assistant 114 or AI assistant evaluation and improvement system 106 for resolving the groundedness errors. The AI assistant evaluation and improvement system 106 uses an error element 704b to do so as described above with respect to the error element 704a. Further, in one or more embodiments, the AI assistant evaluation and improvement system 106 determines similar higher level of detail information as just described for relevance and groundedness for other error metrics (e.g., consistency, completeness, etc. as described above with respect to FIGS. 6A and 6B) using similar error elements 704.

As shown in FIG. 7, in one or more implementations, the AI assistant evaluation and improvement system 106 determines hallucination text included in the response via a hallucination element 706. In some embodiments, the hallucination element 706 is similar to the hallucination element 606 described above. In these or other embodiments, however, the AI assistant evaluation and improvement system 106 uses the hallucination element 706 to revise the hallucination text and/or determine additional detail regarding the hallucination text. For instance, the AI assistant evaluation and improvement system 106 determines additional detail such as probable causes for the errors/error patterns, and or specific improvements to the LLM based artificial intelligence assistant 114 for preventing further hallucinations.

As further illustrated in FIG. 7, in some implementations, the AI assistant evaluation and improvement system 106 uses an error element 704c to revise or provide additional detail regarding source documents for the response. In particular, the AI assistant evaluation and improvement system 106 utilizes the error element 704c to determine whether a database includes documents relevant to a prompt. For instance, the AI assistant evaluation and improvement system 106 generates the error element 704c to include checkboxes similar to the annotation element 604d. in these or other embodiments, the AI assistant evaluation and improvement system 106 utilizes the checkboxes of the error element 704c to determine whether a database includes documents relevant to the prompt. Moreover, in one or more embodiments, the AI assistant evaluation and improvement system 106 generates the error element 704c to include an additional input (e.g., a text input). In one or more implementations, via such an additional text input, the AI assistant evaluation and improvement system 106 determine which documents of a database are relevant to the prompt. For example, in some embodiments, the AI assistant evaluation and improvement system 106 determines links for accessing the relevant documents via the error element 704c. Additionally, or alternatively, the AI assistant evaluation and improvement system 106 determines portions of a document relevant to the prompt via the error element 704c.

As mentioned above, in some implementations, the AI assistant evaluation and improvement system 106 uses the error elements and/or the hallucination element 706 to determine specific improvements to the LLM based artificial intelligence assistant 114 for preventing further errors. For example, the AI assistant evaluation and improvement system 106 determines specific improvements in many forms depending upon the errors/error patterns. To illustrate, the AI assistant evaluation and improvement system 106 determines specific improvements for prompt engineering, training and improving inhouse models, creating new templates and patterns for synthetic data, improving the user experience, optimizing specialized data indexes that the LLM based artificial intelligence assistant 114 queries (e.g., fine-tuning embeddings or updating database schema, etc. In one or more embodiments, the AI assistant evaluation and improvement system 106 utilizes these specific improvements with the error classifications to determine modifications to the LLM based artificial intelligence assistant 114 that are implemented via the engines as described above with respect to FIG. 5.

As noted above, in one or more implementations, the AI assistant evaluation and improvement system improves the accuracy of responses generated by the LLM based artificial intelligence assistant. Indeed, in some embodiments, the sys improves accuracy of such responses by modifying the LLM based artificial intelligence assistant based on severity-classified errors in the responses. FIG. 8 illustrates out-of-scope errors generated by the LLM based artificial intelligence assistant in a first sprint compared with out-of-scope errors generated by a modified LLM based artificial intelligence assistant in a second sprint in accordance with one or more embodiments.

As depicted in FIG. 8, the table compares various types of errors classified as one of high-severity, mid-severity, or low-severity. Specifically, the table illustrates that out-of-scope errors (shown inside a box) were the largest contributor by percentage (i.e., 21.6 %) of high-severity errors in sprint 1. In sprint 1, the LLM based artificial intelligence assistant 114 generated various responses to various prompts. Between sprint 1 and sprint 2, the AI assistant evaluation and improvement system 106 implemented various embodiments of the disclosure as described above with respect to FIGS. 1-7. For example, the AI assistant evaluation and improvement system 106 performed classified the errors based on indications of errors which were in turn based on annotated errors. Based on this classification, the AI assistant evaluation and improvement system 106 generated a modification to the LLM based artificial intelligence assistant 114 focusing on resolving these high-severity out-of-scope errors. In particular, the AI assistant evaluation and improvement system 106 generated and implemented an out-of-scope text classifier using an in-house model.

In this example, the out-of-scope text classifier achieved 90% precision and successfully reduced the high-severity out-of-scope errors in the second sprint. As shown in FIG. 8 for example, the percentage of high-severity out-of-scope errors generated by the LLM based artificial intelligence assistant 114 in sprint 2 was reduced to 6.2% (also shown within a box).

Turning to FIG. 9, additional detail will now be provided regarding various components and capabilities of the AI assistant evaluation and improvement system 106. In particular, FIG. 9 illustrates an example schematic diagram of a computing device 900 (e.g., the server device(s) 102 and/or the client device 110) implementing the AI assistant evaluation and improvement system 106 in accordance with one or more embodiments of the present disclosure for components 900-906. As illustrated in FIG. 9, the AI assistant evaluation and improvement system 106 includes an LLM based artificial intelligence assistant 114, an annotation tool 204, an error analysis mechanism 206, an error classification manager 902, a modification manager 904, and data storage 906.

In some implementations, the LLM based artificial intelligence assistant 114 receives prompts and accesses digital information sources to generate responses to the prompts. For example, the LLM based artificial intelligence assistant 114 receives a prompt via one or more graphical user interfaces such as an artificial intelligence assistant graphical user interface. Furthermore, in one or more embodiments, the LLM based artificial intelligence assistant 114 accesses digital information sources such as digital documents in a database or online sources to generate one or more responses to the prompts. Additionally, in one or more implementations, the LLM based artificial intelligence assistant 114 interacts with other components of the AI assistant evaluation and improvement system 106 to further process the responses, prompts, and digital information sources.

In some embodiments, the annotation tool 204 generates annotated responses as part of determining errors in the responses to the prompts. For example, the annotation tool 204 receives the responses, prompts, and/or digital information sources such as digital documents from the LLM based artificial intelligence assistant 114. Further, in some implementations, the annotation tool 204 generates the annotated responses by modifying the prompts and/or response. For example, the annotation tool 204 modifies the prompts and/or responses to include error identification annotations via an annotation graphical user interface. Moreover, in one or more embodiments, the annotation tool 204 interacts with other components of the AI assistant evaluation and improvement system 106 to further process the annotated responses, such as by providing the annotated responses to reviewer devices of the error analysis mechanism 206.

In one or more implementations, the error analysis mechanism 206 generates indications of the errors based on the annotated responses. For example, in some embodiments, the error analysis mechanism 206 receives the annotated responses from the annotation tool 204. Furthermore, in some implementations, the annotation tool 204 receives an indication of the errors from the reviewer devices via an error graphical user interface. Additionally, in one or more embodiments, the error analysis mechanism 206 interacts with other components of the AI assistant evaluation and improvement system 106 to further process the indications of the errors.

In one or more implementations, the error classification manager 902 classifies the errors according to a severity classification structure. For example, the error classification manager 902 receives the indications of the errors from the error analysis mechanism 206 and classifies the errors based on the indications of the errors. Specifically, in some embodiments, the error classification manager 902 classifies the errors as one of high-severity, mid-severity, or low-severity. In some implementations, the error classification manager 902 classifies the errors as high-severity rather than as a mid-severity error or a low-severity error by determining that the response includes a hallucination. Further, in one or more embodiments, the error classification manager 902 interacts with other components of the AI assistant evaluation and improvement system 106 to further process the classified errors.

The modification manager 904 generates a modification to the LLM based artificial intelligence assistant 114. For example, the modification manager 904 receives the classified errors from the error classification manager 902. In particular, in one or more implementations, the modification manager 904 utilizes the high-severity errors to generate a modification to the LLM based artificial intelligence assistant 114. For example, the modification manager 904 generates the modification, such as a modification to one or more components of the LLM based artificial intelligence assistant 114, to address one or more of the high-severity errors. In some embodiments, the modification manager 904 utilizes engines to generate the modification to the LLM based artificial intelligence assistant 114.

The data storage 906 stores datasets, documents, prompts, responses, annotated responses, indications of errors, and pre-trained models. For example, the data storage 906 stores digital documents accessed from various dataset and stores prompts received by and responses generated by the LLM based artificial intelligence assistant 114. Moreover, the data storage 906 stores annotated responses and indications of errors generated by the annotation tool 204 and the error analysis mechanism 206.

Each of the components 902-906 of the AI assistant evaluation and improvement system 106 can include software, hardware, or both. For example, the components 902-906 can include one or more instructions stored on a computer-readable storage medium and executable by processors of one or more computing devices, such as a client device or server device. When executed by the one or more processors, the computer-executable instructions of the AI assistant evaluation and improvement system 106 can cause the computing device(s) to perform the methods described herein. Alternatively, the components 902-906 can include hardware, such as a special-purpose processing device to perform a certain function or group of functions. Alternatively, the components 902-906 of the AI assistant evaluation and improvement system 106 can include a combination of computer-executable instructions and hardware.

Furthermore, the components 902-906 of the AI assistant evaluation and improvement system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-906 of the AI assistant evaluation and improvement system 106 may be implemented as a stand-alone application, such as a desktop or mobile application. Furthermore, the components 902-906 of the AI assistant evaluation and improvement system 106 may be implemented as one or more web-based applications hosted on a remote server. Alternatively, or additionally, the components 902-906 of the AI assistant evaluation and improvement system 106 may be implemented in a suite of mobile device applications or “apps.” For example, in one or more embodiments, the AI assistant evaluation and improvement system 106 can comprise or operate in connection with digital software applications such as ADOBE® EXPERIENCE PLATFORM, and/or ADOBE® PREMIERE® PRO CREATIVE CLOUD®.

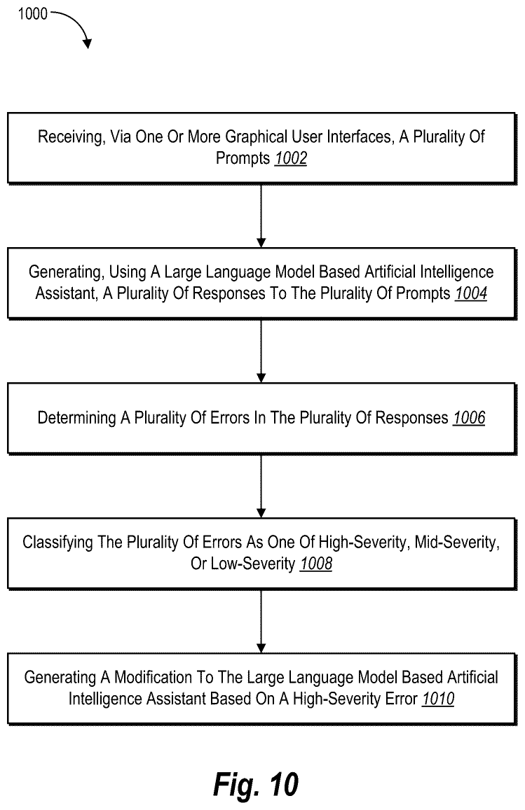

FIGS. 1-9, the corresponding text, and the examples provide a number of different systems, methods, and non-transitory computer readable media for generating modifications to an LLM based artificial intelligence assistant by classifying errors in responses generated by the LLM based artificial intelligence assistant according to severity. In addition to the foregoing, embodiments can also be described in terms of flowcharts comprising acts for accomplishing a particular result. For example, FIGS. 10-12 illustrate flowcharts of example sequences of acts in accordance with one or more embodiments.

While FIGS. 10-12 illustrate acts according to some embodiments, alternative embodiments may omit, add to, reorder, and/or modify any of the acts shown in FIGS. 10-12. The acts of FIGS. 10-12 can be performed as part of a method. Alternatively, a non-transitory computer readable medium can comprise instructions, that when executed by one or more processors, cause a computing device to perform the acts of FIGS. 10-12. In still further embodiments, a system can perform the acts of FIGS. 10-12. Additionally, the acts described herein may be repeated or performed in parallel with one another or in parallel with different instances of the same or other similar acts.

FIG. 10 illustrates an example series of acts 1000 for determining errors in a response, classifying the errors as one of high-severity, mid-severity, or low-severity, and generating a modification to a LLM based artificial intelligence assistant based on a high-severity error. The series of acts 1000 can include an act 1002 of receiving, via one or more graphical user interfaces, a plurality of prompts; an act 1004 of generating, using a large language model based artificial intelligence assistant, a plurality of responses to the plurality of prompts; an act 1006 of determining a plurality of errors in the plurality of responses; an act 1008 of classifying the plurality of errors as one of high-severity, mid-severity, or low-severity; and an act 1010 of generating a modification to the large language model based artificial intelligence assistant based on a high-severity error.

In some embodiments, the series of acts 1000 includes receiving, via one or more graphical user interfaces, a plurality of prompts. In some implementations, the series of acts 1000 also includes an act of generating, using a large language model based artificial intelligence assistant, a plurality of responses to the plurality of prompts. In one or more embodiments, the series of acts 1000 further includes an act of determining a plurality of errors in the plurality of responses. Additionally, in one or more implementations, the series of acts 1000 includes an act of classifying the plurality of errors as one of high-severity, mid-severity, or low-severity. In some embodiments, the series of acts 1000 also includes an act of generating a modification to the large language model based artificial intelligence assistant based on a high-severity error.

In some implementations, determining the plurality of errors in the plurality of responses includes generating, using an annotation tool, annotated responses including error identification annotations. In one or more embodiments, the series of acts 1000 includes associating one or more of the error identification annotations with at least one prompt of the plurality of prompts or a corresponding response of the plurality of responses. In one or more implementations, determining the plurality of errors in the plurality of responses includes generating, using an error analysis mechanism, indications of the plurality of errors based on the annotated responses. In some embodiments, classifying the plurality of errors as one of high-severity, mid-severity, or low-severity includes classifying an error of the plurality of errors as high-severity by determining that a response appears correct but is incorrect.

In some implementations, classifying the plurality of errors as one of high-severity, mid-severity, or low-severity includes classifying an error of the plurality of errors as mid-severity by determining that a response appears incorrect and cannot be corrected. In one or more embodiments, classifying the plurality of errors as one of high-severity, mid-severity, or low-severity includes classifying an error of the plurality of errors as low-severity by determining that a response appears incorrect and can be corrected.

In one or more implementations, generating the modification to the large language model based artificial intelligence assistant based on the high-severity error includes modifying one or more components of the large language model based artificial intelligence assistant. In some embodiments, modifying the one or more components of the large language model based artificial intelligence assistant includes modifying at least one component of the one or more components of the large language model based artificial intelligence assistant using at least one of a user experience design engine, a prompt improvement engine, an in-house model generation engine, a synthetic data template engine, or a data index optimization engine.

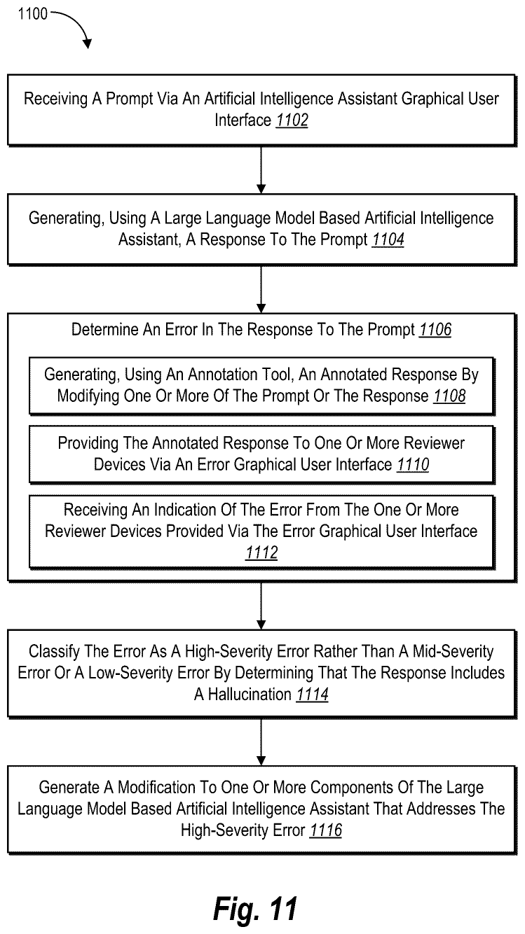

FIG. 11 illustrates an example series of acts 1100 for generating a modification to one or more components of an LLM based artificial intelligence assistant based on a classified error. The series of acts 1100 can include an act 1102 of receiving a prompt via an artificial intelligence assistant graphical user interface; an act 1104 of generating, using a large language model based artificial intelligence assistant, a response to the prompt; an act 1106 of determine an error in the response to the prompt; an act 1108 of generating, using an annotation tool, an annotated response by modifying one or more of the prompt or the response; an act 1110 of providing the annotated response to one or more reviewer devices via an error graphical user interface; an act 1112 of receiving an indication of the error from the one or more reviewer devices provided via the error graphical user interface; an act 1114 of classify the error as a high-severity error rather than a mid-severity error or a low-severity error by determining that the response includes a hallucination; and an act 1116 of generate a modification to one or more components of the large language model based artificial intelligence assistant that addresses the high-severity error.

In some implementations, the series of acts 1100 includes receiving a prompt via an artificial intelligence assistant graphical user interface. In some implementations, the series of acts 1100 further includes an act of generating, using a large language model based artificial intelligence assistant, a response to the prompt. Additionally, in one or more embodiments, the series of acts 1100 includes an act of determining an error in the response to the prompt by generating, using an annotation tool, an annotated response by modifying one or more of the prompt or the response. In one or more implementations, the series of acts 1100 also includes an act of providing the annotated response to one or more reviewer devices via an error graphical user interface. In some embodiments, the series of acts 1100 further includes an act of receiving an indication of the error from the one or more reviewer devices provided via the error graphical user interface. Additionally, in some implementations, the series of acts 1100 includes an act of classifying the error as a high-severity error rather than a mid-severity error or a low-severity error by determining that the response includes a hallucination. In one or more embodiments, the series of acts 1100 also includes an act of generating a modification to one or more components of the large language model based artificial intelligence assistant that addresses the high-severity error.

In one or more embodiments, the series of acts 1100 includes providing the prompt and the response to one or more annotation devices of the annotation tool via an annotation graphical user interface. In one or more implementations, the series of acts 1100 includes generating the annotated response by modifying the one or more of the prompt or the response by generating, via the annotation graphical user interface, error identification annotations. In one or more implementations, the series of acts 1100 further includes an act of associating the error identification annotations with the one or more of the prompt or the response.

In some embodiments, the series of acts 1100 includes classifying the error as a high-severity error rather than a mid-severity error or a low-severity error based on the indication of the error from the one or more reviewer devices. In some implementations, the series of acts 1100 includes classifying the error as high-severity based on the indication of the error from the one or more reviewer devices by determining that the response includes the hallucination, wherein the hallucination includes at least one of a logical consistency, a persuasive concept, or incorrect data that cannot easily be independently verified.

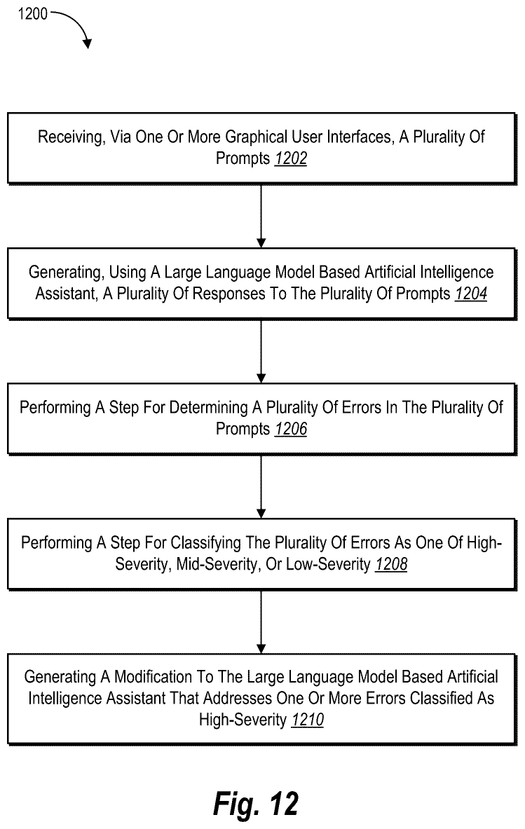

FIG. 12 illustrates an example series of acts 1200 for generating a modification to a LLM based artificial intelligence assistant that addresses response errors classified as high-severity. The series of acts 1200 can include an act 1202 of receiving, via one or more graphical user interfaces, a plurality of prompts; an act 1204 of generating, using a large language model based artificial intelligence assistant, a plurality of responses to the plurality of prompts; an act 1206 of performing a step for determining a plurality of errors in the plurality of prompts; an act 1208 of performing a step for classifying the plurality of errors as one of high-severity, mid-severity, or low-severity; and an act 1210 of generating a modification to the large language model based artificial intelligence assistant that addresses one or more errors classified as high-severity.

In one or more embodiments, the series of acts 1200 includes receiving, via one or more graphical user interfaces, a plurality of prompts. Additionally, in some embodiments, the series of acts 1200 includes an act of generating, using a large language model based artificial intelligence assistant, a plurality of responses to the plurality of prompts. In some implementations, the series of acts 1200 also includes an act of performing a step for determining a plurality of errors in the plurality of prompts. In one or more embodiments, the series of acts 1200 further includes an act of performing a step for classifying the plurality of errors as one of high-severity, mid-severity, or low-severity. Additionally, in one or more implementations, the series of acts 1200 includes an act of generating a modification to the large language model based artificial intelligence assistant that addresses one or more errors classified as high-severity.

In one or more implementations, determining the plurality of errors in the plurality of prompts includes generating, for an error and using an annotation tool, a plurality of annotated responses for at least one prompt or a response corresponding to the at least one prompt. In some embodiments, the series of acts 1200 includes generating, using an error analysis mechanism, an indication of the error based on the plurality of annotated responses.

In some implementations, performing the step for classifying the plurality of errors as one of high-severity, mid-severity, or low-severity includes classifying an error of the plurality of errors as high-severity by determining that a response includes a hallucination, wherein the hallucination includes at least one of a logical consistency, a persuasive concept, or incorrect data that cannot easily be independently verified.

In one or more embodiments, performing the step for classifying the plurality of errors as one of high-severity, mid-severity, or low-severity includes classifying an error of the plurality of errors as mid-severity by determining that a response includes at least one of a non-overridable error message or a logical inconsistency.

In one or more implementations, performing the step for classifying the plurality of errors as one of high-severity, mid-severity, or low-severity includes classifying an error of the plurality of errors as low-severity by determining that a response includes at least one of information not responsive to a corresponding prompt or an overridable error message.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 13 illustrates, in block diagram form, an example computing device 1300 (e.g., the annotation devices 304, the reviewer devices 402, the client device 110, and/or the server device(s) 102) that may be configured to perform one or more of the processes described above. As shown by FIG. 13, the computing device can comprise a processor(s) 1302, memory 1304, a storage device 1306, an I/O interface 1308, and a communication interface 1310.

In particular embodiments, processor(s) 1302 includes hardware for executing instructions, such as those making up a computer program. As an example, and not by way of limitation, to execute instructions, processor(s) 1302 may retrieve (or fetch) the instructions from an internal register, an internal cache, memory 1304, or a storage device 1306 and decode and execute them. The computing device 1300 includes memory 1304, which is coupled to the processor(s) 1302. The memory 1304 may be used for storing data, metadata, and programs for execution by the processor(s). The memory 1304 may include one or more of volatile and non-volatile memories. The memory 1304 may be internal or distributed memory. The computing device 1300 includes a storage device 1306 includes storage for storing data or instructions. As an example, and not by way of limitation, storage device 1306 can comprise a non-transitory storage medium described above. The computing device 1300 also includes one or more input or output (“I/O”) devices/interfaces 1308, which are provided to allow a user to provide input to (such as user strokes), receive output from, and otherwise transfer data to and from the computing device 1300. These I/O devices/interfaces 1308 may include a mouse, keypad or a keyboard, a touch screen, camera, optical scanner, network interface, modem, other known I/O devices or a combination of such I/O devices/interfaces 1308.

The computing device 1300 can further include a communication interface 1310. The communication interface 1310 can include hardware, software, or both. The communication interface 1310 can provide one or more interfaces for communication (such as, for example, packet-based communication) between the computing device and one or more other computing devices (e.g., computing device 1300) or one or more networks. The computing device 1300 can further include a bus 1312. The bus 1312 can comprise hardware, software, or both that couples components of computing device 1300 to each other.

What is claimed is:

1. A computer-implemented method comprising:
receiving, via one or more graphical user interfaces, a plurality of prompts;
generating, using a large language model based artificial intelligence assistant, a plurality of responses to the plurality of prompts;
determining a plurality of errors in the plurality of responses;
classifying the plurality of errors as one of high-severity, mid-severity, or low-severity; and
generating a modification to the large language model based artificial intelligence assistant based on a high-severity error.

2. The computer-implemented method of claim 1, wherein determining the plurality of errors in the plurality of responses comprises generating, using an annotation tool, annotated responses comprising error identification annotations.

3. The computer-implemented method of claim 2, further comprising associating one or more of the error identification annotations with at least one prompt of the plurality of prompts or a corresponding response of the plurality of responses.

4. The computer-implemented method of claim 3, wherein determining the plurality of errors in the plurality of responses comprises generating, using an error analysis mechanism, indications of the plurality of errors based on the annotated responses.

5. The computer-implemented method of claim 1, wherein classifying the plurality of errors as one of high-severity, mid-severity, or low-severity comprises classifying an error of the plurality of errors as high-severity by determining that a response appears correct but is incorrect.

6. The computer-implemented method of claim 1, wherein classifying the plurality of errors as one of high-severity, mid-severity, or low-severity comprises classifying an error of the plurality of errors as mid-severity by determining that a response appears incorrect and cannot be corrected.

7. The computer-implemented method of claim 1, wherein classifying the plurality of errors as one of high-severity, mid-severity, or low-severity comprises classifying an error of the plurality of errors as low-severity by determining that a response appears incorrect and can be corrected.

8. The computer-implemented method of claim 1, wherein generating the modification to the large language model based artificial intelligence assistant based on the high-severity error comprises modifying one or more components of the large language model based artificial intelligence assistant.

9. The computer-implemented method of claim 8, wherein modifying the one or more components of the large language model based artificial intelligence assistant comprises modifying at least one component of the one or more components of the large language model based artificial intelligence assistant using at least one of a user experience design engine, a prompt improvement engine, an in-house model generation engine, a synthetic data template engine, or a data index optimization engine.

10. A system comprising:
one or more memory devices; and
one or more processors coupled to the one or more memory devices, the one or more processors configured to cause the system to:
receive a prompt via an artificial intelligence assistant graphical user interface;
generate, using a large language model based artificial intelligence assistant, a response to the prompt;
determine an error in the response to the prompt by:
generating, using an annotation tool, an annotated response by modifying one or more of the prompt or the response;
providing the annotated response to one or more reviewer devices via an error graphical user interface; and
receiving an indication of the error from the one or more reviewer devices provided via the error graphical user interface;
classify the error as a high-severity error rather than a mid-severity error or a low-severity error by determining that the response includes a hallucination; and
generate a modification to one or more components of the large language model based artificial intelligence assistant that addresses the high-severity error.

11. The system of claim 10, wherein the one or more processors are further configured to provide the prompt and the response to one or more annotation devices of the annotation tool via an annotation graphical user interface.

12. The system of claim 11, wherein the one or more processors are further configured to generate the annotated response by modifying the one or more of the prompt or the response by:
generating, via the annotation graphical user interface, error identification annotations; and
associating the error identification annotations with the one or more of the prompt or the response.

13. The system of claim 10, wherein the one or more processors are further configured to classify the error as a high-severity error rather than a mid-severity error or a low-severity error based on the indication of the error from the one or more reviewer devices.

14. The system of claim 12, wherein the one or more processors are further configured to classify the error as high-severity based on the indication of the error from the one or more reviewer devices by determining that the response includes the hallucination, wherein the hallucination comprises at least one of a logical consistency, a persuasive concept, or incorrect data that cannot easily be independently verified.

15. A computer-implemented method comprising:
receiving, via one or more graphical user interfaces, a plurality of prompts;
generating, using a large language model based artificial intelligence assistant, a plurality of responses to the plurality of prompts;
performing a step for determining a plurality of errors in the plurality of prompts;
performing a step for classifying the plurality of errors as one of high-severity, mid-severity, or low-severity; and
generating a modification to the large language model based artificial intelligence assistant that addresses one or more errors classified as high-severity.

16. The computer-implemented method of claim 15, wherein determining the plurality of errors in the plurality of prompts comprises generating, for an error and using an annotation tool, a plurality of annotated responses for at least one prompt or a response corresponding to the at least one prompt.

17. The computer-implemented method of claim 16, further comprising generating, using an error analysis mechanism, an indication of the error based on the plurality of annotated responses.

18. The computer-implemented method of claim 15, wherein performing the step for classifying the plurality of errors as one of high-severity, mid-severity, or low-severity comprises classifying an error of the plurality of errors as high-severity by determining that a response includes a hallucination, wherein the hallucination comprises at least one of a logical consistency, a persuasive concept, or incorrect data that cannot easily be independently verified.

19. The computer-implemented method of claim 15, wherein performing the step for classifying the plurality of errors as one of high-severity, mid-severity, or low-severity comprises classifying an error of the plurality of errors as mid-severity by determining that a response comprises at least one of a non-overridable error message or a logical inconsistency.

20. The computer-implemented method of claim 15, wherein performing the step for classifying the plurality of errors as one of high-severity, mid-severity, or low-severity comprises classifying an error of the plurality of errors as low-severity by determining that a response comprises at least one of information not responsive to a corresponding prompt or an overridable error message.
